(19) United States
(12) Patent Application Publication
(10) Pub. No.: US 2025/0388400 A1
(43) Pub. Date: Dec. 25, 2025

(54) Robotic Pick and Pack Station and Method of Use Thereof

(71) Applicant: Chewy, Inc., Plantation, FL (US)

(72) Inventors: Tim Foley, Woburn, MA (US); Olivia McCafferty, Winthrop, MA (US); Amelia Smith, Boston, MA (US); Raj Tejas Suryaprakash, Bellingham, WA (US); Luke Matthew Mehring, San Diego, CA (US); Scott Herscher, St. Paul, MN (US); Carlos Fitts, Woodbury, MN (US); Jessica Cano, Woburn, MA (US); Venkata Siva Naga Chaitanya Chunduru, Woburn, MA (US); Matthew Repetto, Natick, MA (US); Colin Dignam, Woburn, MA (US)

(73) Assignee: Chewy, Inc., Plantation, FL (US)

(21) Appl. No.: 18/880,147

(22) PCT Filed: Mar. 14, 2024
(86) PCT No.: PCT/US2024/019878

§ 371 Date: Dec. 30, 2024

Related U.S. Application Data
(60) Provisional application No. 63/490,206, filed on Mar. 14, 2023.

(51) Int. Cl. B65G 1/137; B25J 9/00; B25J 9/16; B65B 5/04; B65B 35/18; B65B 43/26; B65B 43/52; B65B 57/12; B65B 61/02; B65B 65/00; B65G 59/04; G06Q 10/087

(52) U.S. Cl. CPC B65G 1/1373; B25J 9/0093; B25J 9/1697; B65B 5/04; B65B 35/18; B65B 43/265; B65B 43/52; B65B 57/12; B65B 61/025; B65B 65/003; B65G 59/04; G06Q 10/0874; B65G 2203/0216

(57) ABSTRACT

A robotic pack station includes a work cell that includes a robotic arm with an end effector coupled thereto and a plurality of pick sites radially disposed about the robotic arm. Each pick site includes packages arranged in a stack. An image capture system is configured to capture images of the pick sites and a container conveyor is coupled to the work cell and configured to move one or more containers into the work cell. An industrial control server in communication with the robotic arm and with the image capture system is configured to control movement of the robotic arm and actuation of the end effector to transfer selected packages from one of the plurality of pick sites to one of the containers conveyed into the work cell, based on the images.

### CROSS-REFERENCE TO RELATED APPLICATIONS

This application claims the benefit of U.S. Provisional Patent Application No. 63/490,206 filed Mar. 14, 2023 entitled “Robotic Pick and Pack Station and Method of Use Thereof”, which is incorporated by reference herein in its entirety.

### TECHNICAL FIELD

The present disclosure generally relates to automated systems and methods for picking and packaging products, and specifically to systems and methods for picking packaged products and placing packaged products in a shipping container using a robotic arm.

### SUMMARY

In one embodiment there is a robotic pack station including a work cell including a robotic arm with an end effector coupled thereto and a plurality of pick sites radially disposed about the robotic arm, each pick site comprising packages arranged in a stack, an image capture system configured to capture images of the pick sites, a container conveyor coupled to the work cell and configured to move one or more containers into the work cell, an industrial control server in communication with the robotic arm and with the image capture system, the industrial control server configured to control movement of the robotic arm and actuation of the end effector to transfer selected packages from one of the plurality of pick sites to one of the containers conveyed into the work cell, based on the images.

In some embodiments, each package comprises a flexible outer film surrounding bulk material that engages the flexible outer film to conform the package into a first shape in an unpicked configuration and into a second shape in a picked configuration, wherein the first shape is different from the second shape. In some embodiments, one or more of the packages has a package footprint in the stack defined by a length and width of the package that is greater than a container footprint of a corresponding container. In some embodiments, adjacent stacked packages at the pick site are arranged in an overlapping configuration. In some embodiments, the end effector comprises a suction based end effector.

In some embodiments, the robotic pack station further includes an order fulfillment server system in communication with the industrial control server, the order fulfillment server configured to transmit instructions to the industrial control server to cause the robotic arm to retrieve one or more packages containing requested products for placement in the container. In some embodiments, the order fulfillment server includes a database storing product-specific information therein, a warehouse management server configured to receive one or more product requests and retrieve product-specific information corresponding the one or more product requests, an intermediary server, in communication with the warehouse management server and in communication with the industrial control server, the intermediary server configured to receive order-specific information for a plurality of pending orders from the warehouse management server and, for each received pending order, update a queue of pending orders including ranking the pending orders for processing based on the order-specific information, and the intermediary server is further configured to transmit to the industrial control server, the order-specific information of pending orders in the queue according to a priority ranking.

In some embodiments, the order-specific information for each of the plurality of orders including at least one of i) product identity information, ii) container size information, iii) order identifier information, iv) shipping information, v) order priority information, and vi) designated pick site information. In some embodiments, the industrial control server is configured to in response to receiving order-specific information for a pending order, determine a pick site corresponding to the order-specific information, cause the image capture system to capture an image of the determined pick site, determine, based on the image, package position information corresponding to a selected package at the determined pick site, determine, based on the package position information, a pick point corresponding to a geometric center on the selected package, and cause the robotic arm to pick the selected package at the pick point. In some embodiments, the determined package position information includes a determined package footprint defined by a long edge and short edge of the package, and the pick point is a center point of the package with respect to the long and short edges of the package.

In some embodiments, the industrial control server is configured to determine an orientation of the selected package within a 3-dimensional space based on the images and generate package orientation information, cause the robotic arm to reorient the end effector from a first orientation to a second orientation such that the orientation of the end effector is generally the same as the orientation of the selected package and, while in the second orientation, activate the end effector such that the selected package is picked, and control movement of the robotic arm such that the long and short edges of the selected package are aligned with a long edge and a short edge of the container conveyed into the work cell. In some embodiments, the robotic pack station further includes a container erector coupled to the container conveyor and in communication with the industrial control server, the container erector configured to erect the container selected from a store of containers of different sizes, based on the received order-specific information, an indicia applicator configured to generate and apply an indicia to the erected container, the indicia including a visual indication associated with the order identifier information included in the received order-specific information.

In some embodiments, in response to receiving order specific information corresponding to the pending order information, the industrial control server is configured to cause the container erector to erect a container having dimensions defined by the container size information, cause the indicia applicator to generate and apply indicia to the erected container, the indicia including the order identifier information associated with the order-specific information, cause the container conveyor to transport the erected container having the indicia into the work cell. In some embodiments, the pack station further includes a transfer table positioned within the work cell and coupled to the container conveyor, and a first container sensor coupled to the container conveyor and positioned between the indicia applicator and transfer table, the first container sensor in communication with the industrial control server and configured to detect the position of the container, and the industrial control server is configured to, in response to receiving an indication from the first container sensor that the container is detected, cause the robotic arm to retrieve the selected package.

In some embodiments, the robotic pack station further includes a second container sensor coupled to the transfer table, the second container sensor in communication with the industrial control server and configured to detect a position of the container on the transfer table, a displacement rake in communication with the industrial control server and configured to, in response to receiving an indication from the second container sensor that the container is detected, position the container in a retained position, and the container is a regular slotted container and in the retained position the container is erected with four extended flaps and wherein the industrial control server is configured to, cause the robotic arm to place the selected package into the container in the retained position without folding one or more of the flaps. In some embodiments, the industrial control server is configured to place the selected package in the container such that the pick point of the selected package is positioned directly above a center point of the container within a tolerance of at least 3/1000 of a inch.

In some embodiments, the plurality of pick sites includes at least thirteen pick sites spaced circumferentially about the robotic arm. In some embodiments, the intermediary server is configured to transmit an indication to the warehouse management server that the selected package has been prepared for shipping, after the robotic arm has placed the selected package in the container, and the warehouse management server is configured to, in response to receiving an indication from the intermediary server that the package has been prepared for shipping, update a stored inventory amount for the product associated with the package. In some embodiments, the intermediary server is configured to determine a work cell inventory amount of each specific product included in each stack of packages positioned within the work cell, and, in response to an inventory amount for a specific product being equal to or less than a predetermined threshold, transmit a request to the warehouse management server for a predetermined restock amount of that specific product. In some embodiments, the image capture system includes a plurality of image capture devices, each image capture device of the plurality of image capture devices being positioned to capture images of one of the pick sites. In some embodiments, each package in the stack is positioned in an orientation that is different from an orientation of at least one adjacent package in the stack.

In another embodiment there is a method of picking and packing a flexibly packaged product within a shipping container, the method includes at an industrial control server, receiving an order request for a packaged product, the order request including an indication of a requested product and customer specific information, at a container erector in communication with the industrial control server, receiving a shipping container in a blank configuration and erecting the shipping container, at an indicia applicator, applying a label to the erected shipping container, the label including indicia corresponding to the customer specific information, at the industrial control server, causing a container conveyor to transport the erected shipping container with the label applied thereto to a first location, at a first case detection device coupled to the container conveyor proximate the first location, detecting a presence of the erected shipping container and transmitting a first signal to the industrial control server, at the industrial control server, in response to receiving the first signal causing a robotic arm with an end effector coupled thereto and positioned within a work cell, to retrieve a specific package corresponding to the requested product, wherein the specific package is located at a specific pick site of a plurality of pick sites radially disposed about the robotic arm, causing the container conveyor to transport the erected shipping container to a transfer table positioned within the work cell, at a second case detection device coupled to the transfer table and in communication with the industrial control server, detecting the presence of the erected shipping container at a first position on the transfer table, and transmitting a second signal to the industrial control server, and at the industrial control server, in response to receiving the second signal, causing a displacement device to displace the erected shipping container from the first position on the transfer table to a second position on the transfer table and retain the erected shipping container at the second position, and causing the robotic arm to place the retrieved specific package within the erected shipping container.

In some embodiments, each pick site includes a plurality of packages and the packages are arranged in a plurality of stacks, each stack comprising a plurality of packages containing a bulk quantity of a product, and wherein each stacked package is positioned in an orientation that is different from at least one adjacent stacked package. In some embodiments, causing the robotic arm to retrieve a specific package corresponding to the requested product includes, at the industrial control server automatically determining which of the pick sites includes the requested product, causing an image capture system in communication with the industrial control server to capture an image of the determined pick site, determine, based on the image, package position information corresponding to the pick site, determine, based on the package position information, a packaged product for retrieval, determine an center point of the packaged product for retrieval based on the image, cause the robotic arm to position the end effector at the determined center point with a tolerance of about 3/1000 of an inch, and activate the end effector to cause the packaged product to be retrieved by the robotic arm. In some embodiments, causing the robotic arm to place the retrieved package in the erected shipping container includes, at the industrial control server, determining a center point of the erected package at the second position on the transfer table, causing the robotic arm to place the retrieved packaged product in the erected shipping container such that the center point of the retrieved packaged product is directly above the center point of the erected shipping container.

### BRIEF DESCRIPTION OF THE DRAWINGS

The following detailed description of embodiments of the system and method, will be better understood when read in conjunction with the appended drawings of exemplary embodiments. It should be understood, however, that the invention is not limited to the precise arrangements and instrumentalities shown.

In the drawings:

FIG. 1 is diagram of a robotic pack station in accordance with an exemplary embodiment of the present disclosure;

FIG. 2 is a perspective view of a work cell of the robotic pack station of FIG. 1;

FIG. 3 is a perspective view of a robotic arm of the robotic pack station of FIG. 1;

FIG. 4 is a perspective view of the robotic arm of the robotic pack station of FIG. 1;

FIG. 5 is a perspective view of the work cell of the robotic pack station of FIG. 1 with one or more pick sites being empty;

FIG. 6 is a magnified perspective view of the work cell shown in FIG. 5;

FIG. 7 is a magnified perspective view of an access door of the work cell in a locked state;

FIG. 8 is a partial view of the access door of FIG. 7 open and in an unlocked state;

FIG. 9 is a cross-sectional illustration of a flexible package that may be positioned within a work cell;

FIG. 10 is a perspective view of an example stack of packages in a first shape;

FIG. 11 is a perspective view of a package in a second shape;

FIG. 12 is a perspective view of another example stack of packages in a first shape;

FIG. 13 is an image captured by the image capture system of the robotic pack station of FIG. 1;

FIG. 14 is an illustration of package recognition performed by the industrial control server included in the robotic pack station of FIG. 1;

FIG. 15 is an illustration of an end effector of the robotic pack station of FIG. 1 oriented relative to a package footprint of a package to be picked;

FIG. 16 is an illustration of an erected container for use in the robotic pack station of FIG. 1;

FIG. 17 is a top elevational view of the erected container of FIG. 16;

FIGS. 18A-18C are perspective view of a container being transported along a container conveyor of the robotic pack station of FIG. 1 and having a indicia applied thereto;

FIG. 19A is a perspective view of a transfer table of the robotic pack station of FIG. 1;

FIGS. 19B-19C are magnified views of different portions of the transfer table of FIG. 19A;

FIGS. 20A-20H are perspective views illustrating an instance of the robotic pack station of FIG. 1 picking and placing a flexible package into a shipping container;

FIG. 21 is a system diagram of the robotic pack station of FIG. 1 in accordance with an exemplary embodiment of the present disclosure;

FIG. 22 is a flowchart illustrating a method of picking and packing a flexibly packaged product within a shipping container in accordance with an exemplary embodiment of the present disclosure; and

FIGS. 23A-23J are perspective views illustrating another instance of the robotic pack station of FIG. 1 picking and placing a flexible package into a shipping container.

### DETAILED DESCRIPTION

Systems and methods for the transfer of packaged products from a storage location (e.g., a pallet within a warehouse) into a shipping container (e.g., a cardboard box) to be delivered to a respective customer is referred to as “pick-and-pack” Systems and methods. Packages that are large, asymmetrical, deformable, and/or heavy present challenges to automated handling systems that may be operated more efficiently when packages are uniformly presented for picking and packing. Furthermore, the flexible nature of the packaging and/or weight of the packages presents difficulty to automated pick-and-pack processes. For example, accurately and consistently placing a packaged product within a shipping container without damaging the shipping container and/or the packaged product becomes increasingly difficult when the package is 1) staged in a non-uniform fashion, is susceptible to deformation when stacked or picked, 2) prone to weight shifting, and/or 3) has flexible outer packaging (e.g., bulk material packages such as pet food, granulated material, powders and the like). As such, there is a need to provide an automated system and method for automatically picking and packing products that are flexibly packaged, staged in a non-uniform fashion and/or are prone to weight shifting.

Numerous details are described herein in order to provide a thorough understanding of the example embodiments illustrated in the accompanying drawings. However, some embodiments may be practiced without one or more of the specific details, and the scope of the claims is only limited by those features and aspects specifically recited in the claims. Furthermore, well-known methods, components, and circuits have not be described in exhaustive detail so as not to unnecessarily obscure pertinent aspects of the embodiments described herein.

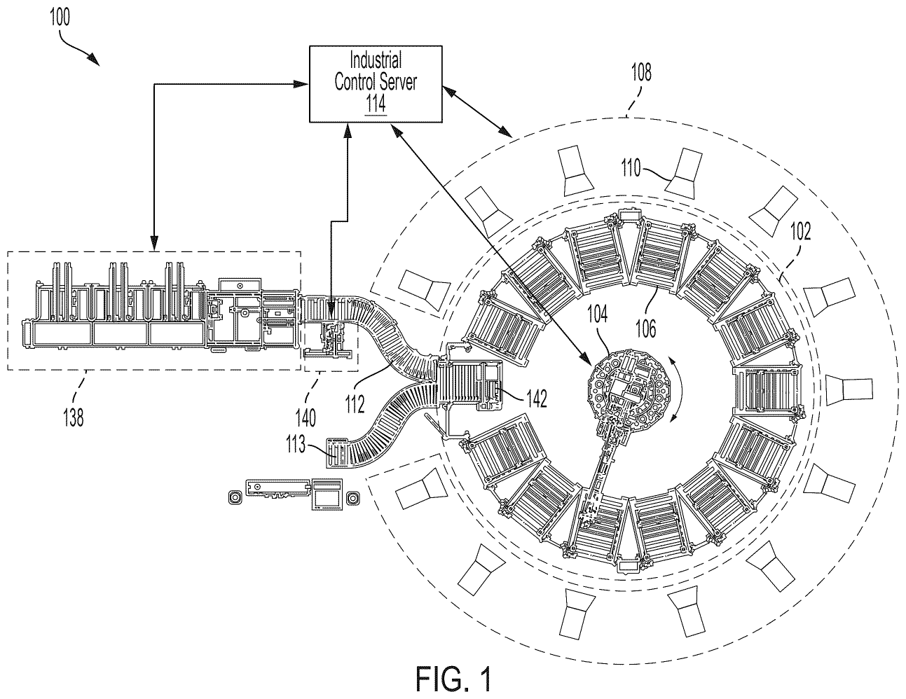

Referring to the drawings in detail, wherein like reference numerals indicate like elements throughout, there is shown in FIGS. 1-23J, in accordance with an exemplary embodiment of the present disclosure.

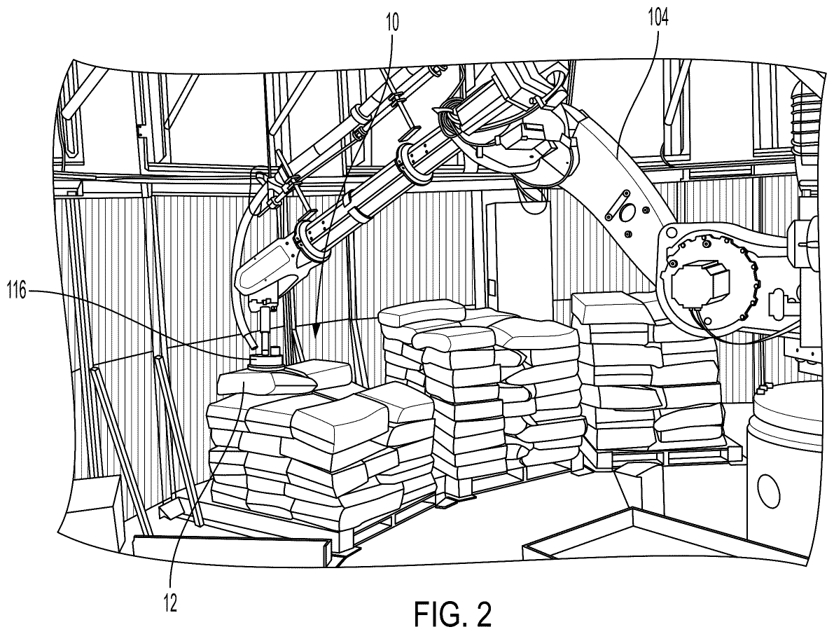

Referring to FIGS. 1-2 there is shown an embodiment of a robotic pack station, generally designated 100, in accordance with an exemplary embodiment of the present disclosure. The robotic pack station 100 may be configured to automatically transfer packages containing a product offered for sale from one or more storage locations into to a shipping container (e.g., shipping box) using a robotic arm. The robotic pack station 100 of the present disclosure may be configured to automatically retrieve items having a flexible packaging accurately place them into a shipping container for shipment to a customer. The flexible packaging may include any non-rigid packaging having a shape that results at least in part from the product contained within the package such as a bulk pet food package. In some case the flexible packaging may include bags, pouches, liners, wraps, rollstock and other flexible products and may be entirely or substantially produced from paper, plastic, film, foil or combinations thereof.

The robotic pack station 100 may include a work cell 102 including a robotic arm 104 and a plurality of pick sites 106 radially disposed about the robotic arm 104. The work cell 102 may store a plurality of packaged products to be retrieved by the robotic arm 104 and placed by the robotic arm 104 within a container (e.g., a shipping container). A pick site 106 may be a location at which packaged products are positioned to be retrieved by the robotic arm 104. In some embodiments pick sites 106 may generally have positioned therein packages arranged in a stack. For example, a pallet supporting a stacked plurality product (e.g., as shown in FIG. 2) may be positioned within a pick site 106 such that the product can be retrieved from the stack via the robotic arm 104. Not all of the pick sites 106 are labelled in FIG. 1 so as not to clutter the figure, however it should be understood that there are a plurality of pick sites 106 included in the work cell 102. In FIG. 1, there are thirteen pick sites 106 radially disposed about the robotic arm 104. In some embodiments, there are fewer than or more than thirteen pick sites 106 radially disposed about the robotic arm 104. There may be a stack 10 of packages 12 (shown in FIG. 2) positioned within one or more of the pick sites 106 such that the robotic arm 104 may retrieve packages 12 from any one of the stacks 10. The robotic pack station 100 may include an image capture system 108 configured to capture images at the pick sites 106. In some embodiments the image capture system 108 includes a plurality of image capture devices 110 (e.g., cameras). In some embodiments, the number of image capture devices 110 corresponds to the number of pick sites 106. For example, there may be at least one image capture device 110 for each pick site 106.

In some embodiments, one or more of the pick sites 106 include a stack 10 of packages 12 corresponding to a product that is different from a stack 10 of packages 12 at a different pick site 106. For example, each stack 10 may be comprised of packages 12 containing the same product (e.g., the same package of pet food). As such, one or more of the pick sites 106 may include a stack 10 of a first packaged product and one or more other pick sites 106 may include a stack of a second packaged product that is different from the first. In some embodiments, each pick site 106 includes a stack 10 of packages 12 corresponding to different products. For example, each pick site 10 may include a stack 10 of packaged products that are different from each other stack 10 at each other pick site 106. The number of pick sites 106 may correspond to the number of different stacks 10 of packaged products positioned therein. For example, if the number of pick sites 106 is thirteen then there may be, in some instances, stacks 10 of thirteen different packaged products positioned one at each pick site 106.

In some embodiments, stacks 10 of different packaged products 12 are arranged at pick sites 106 based on one or more of, expected or historical sales data and physical characteristics of the packaged product 12. For example, package 12 that are expected to, or historically have, sold more quickly or at higher volumes may be placed at pick sites 106 that are closer to a location in the work cell 102 where the packages 12 are moved for placing into a shipping container (e.g., the transfer table 142 described in more detail below). In some embodiments, the physical characteristics of packages 12 may result in the packages 12 being at a higher risk of being dropped by the robotic arm 104 than other packages 12. For example, some packages 12 may include perforations or be generally more flexible than others. Some packages, for example, may have a shape that deforms from the weight of the package contents as the package is picked. As such, those packages 12 at a higher risk of being dropped may be placed at a pick site 106 closer to the location in the work cell 102 where the packages 12 are moved for placing into a shipping container. In this manner, the travel distance and time required to move the packages 12 from a stack 10 into a shipping container is minimized thereby reducing the risk of the package 12 being dropped.

The robotic pack station 100 may include a container conveyor 112 coupled to the work cell 102 and configured to move one or more containers into the work cell 102. For example, the container conveyor 112 may be configured to move containers into the work cell 102 such that the robotic arm 104 may place a retrieved package 12 into the container. The robotic pack station 100 may include an industrial control server 114 in communication with the robotic arm 104 and with the image capture system 108 such that the industrial control server 114 may control operation of both. For example, the industrial control server 114 may control the movement of the robotic arm 104 based on images received from the image capture system 108.

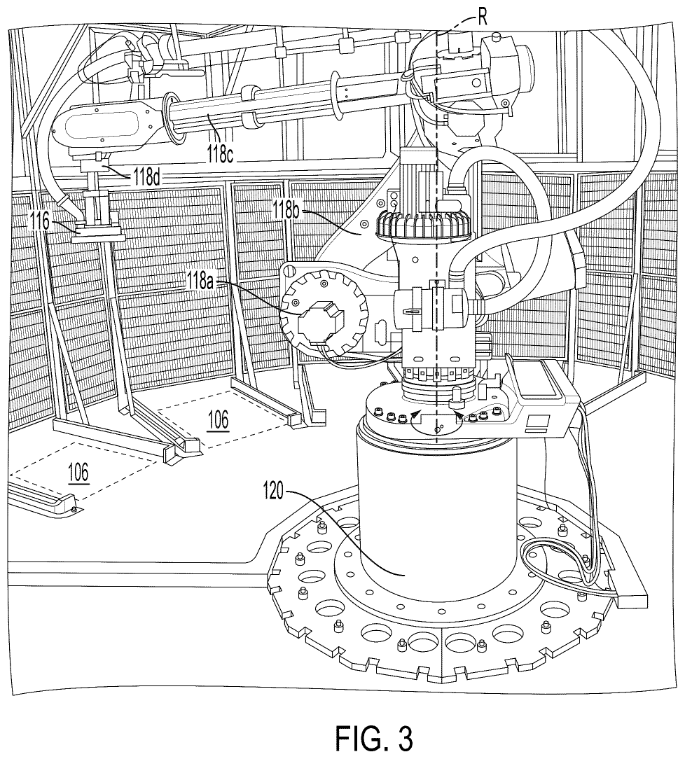

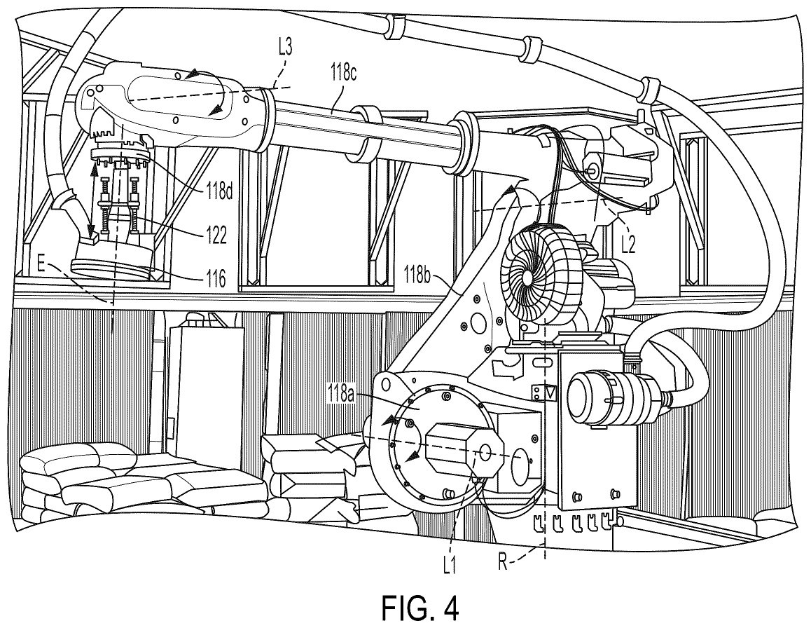

Referring to FIGS. 3-4 the robotic arm 104 is shown in an initial position, alternatively referred to as a non-extended position or a resting position. The robotic arm 104 includes an end effector 116 coupled thereto and configured to retrieve a package 12. The end effector 116 may be a gripping end effector that is configured to grip and hold a package 12. In some embodiments, the end effector 116 is a suction based end effector, or vacuum end effector, that includes one or more suction grippers or suction pads powered by a vacuum source, that when activated, enables the end effector to grip a package 12. In some embodiments, the end effector 116 may include a cushion at the distal end and configured to abut a package 12 when the end effector 116 grips the package. In some embodiments, the cushion is comprised of a foam rubber material.

The robotic arm 104 may be configured to move a package 12 gripped by the end effector 116 from one location to another. In some embodiments, the robotic arm 104 includes one or more linkage members 118a-118d coupling the end effector 116 to a base 120 of the robotic arm 104. The linkage members 118a-118d and end effector 116 may be rotatable relative to the base 120 about a radial axis R that allows the robotic arm 104 to rotate about axis R within the work cell 102. For example, the first linkage member 118a may be rotatable relative to the base 120 about the radial axis R. As such, the robotic arm 104 may be rotatable about axis R such that it may orient the end effector 116 towards any one of the pick sites 106 disposed radially about the robotic arm 104. In some embodiments, the turn radius about the radial axis R may be 360 degrees. In some embodiments, the position of the base 120 is fixed relative to the pick sites 106. In some embodiments, the base 120 is generally centered within the work cell 102. In some embodiments, the pick sites are each positioned radially around the radial axis R at a distance generally equal to one another. In other embodiments, the base 120 may be placed on a track (not shown) such that the base 120 may be moveable relative to the pick sites 106.

One or more of the linkage members 118a-118b may be rotatable relative to one another to allow the robotic arm 104 to selectively position the end effector 116 at different locations within the work cell 102. For example, the second linkage member 118b may be rotatable relative to the first linkage member about a first linkage axis L1. The third linkage member 118c may be rotatable relative to the second linkage member 118b about a second linkage axis L2. Similarly, the fourth linkage member 118d may be rotatable relative to the third linkage member 118c about a third linkage axis L3. Each of the linkage axes L1-L3 may be generally parallel to one another and generally perpendicular to the radial axis R.

The end effector 116 may be coupled to the robotic arm by the fourth linkage member 118d. In some embodiments, the fourth linkage member 118d defines an end effector axis E that is generally perpendicular to the third linkage axis L3. The end effector axis E may be normal to a bottom planar surface of the end effector 116. In some embodiments, the end effector 116 is moveable along the end effector axis E. For example, there may be one or more biasing members 122 coupling the end effector 116 to the fourth linkage member 118d. In this manner, when the end effector 116 is pressed against a surface (e.g., the surface of a package 12) by the robotic arm 104, the end effector 116 may translate along the end effector axis E towards the fourth linkage member 118d. In some embodiments, the fourth linkage member 118d and/or biasing members 122 may be configured to constrain the movement of the end effector 116 relative to the fourth linkage member 118d to be along the end effector axis E. The biasing members 122 may be springs, or any other suitable type of biasing element. Although four linkage members 118a-118d are illustrated in the figures, it should be understood that the robotic arm 104 may include any number of linkage members.

The industrial control server 114 may be configured to cause the robotic arm 104 to position the end effector 116 at different locations within the work cell. For example, the industrial control server 114 may be configured to control movement of the linkage members 118a-118d about the radial axis R and/or relative to one another about the linkage axes L1-L3. In some embodiments, the industrial control server 114 is configured to position the end effector 116 at packages 12 positioned within pick sites 106. The industrial control server 114 may be configured to selectively activate and deactivate a vacuum source coupled to the end effector 116 to control activation of the end effector 116. In this manner, the industrial control server 114 may control movement and/or activation of the end effector 116 such that the robotic arm 104 may pick a package 12 from any one of the pick sites 106, move it to a desired location and place the package 12 at the desired location.

Referring to FIGS. 1 and 5-6, the pick sites 106 may be locations within the work cell 102 where different packages 12 are stored for picking by the robotic arm 104. Each pick site 106 may be positioned radially around the robotic arm 104 as discussed above. In this manner, the distance between any one pick site 106 from the robotic arm 104 may be generally the same as the distance between a different pick site 106 and the robotic arm 104. In some embodiments, there are 13 pack sites 106 disposed radially about the robotic arm 104 and spaced from one another. In some embodiments, each pick site 106 include one or more guide elements 124 to assist in positioning a stack 10 of packages therein. For example, the guide elements 124 may include guide rails disposed at least partially about a periphery of each pick site 106 and fixed relative to the robotic arm 104. As such, a stack 10 of packages 12 positioned within the work cell 102 such that stack 10 is within a desired pick site 106. So configured, stack 10 may abut the guide elements 124.

For example, the guide elements 124 may include a distal end disposed along a peripheral edge of each pick site 106 closest to the robotic arm 104. The distal end of the guide elements 124 may be sized to prevent a stack 10 from being placed within the pick site 106 such that the stack extends past that peripheral edge of the pick site 106. As such, movement of a stack 10 into the work cell 102 may include positioning the stack 10 against the distal end of the guide elements 124 in order to readily position the stack 10 at the desired location within the pick site 106. In some embodiments, the stack 10 of packages 12 is a palletized stack including a pallet upon which the packages 12 are placed. As such, introduction of a stack of palletized packages into the work cell 102 may lead to movement of the pallet into the desired pick site 106 (e.g., such that the pallet abuts the distal end of the guide elements 124). In some embodiments, each pick site 106 is generally the same size (e.g., has generally the same footprint). For example, each pick site 106 may have a footprint of about forty inches wide and about fifty inches long. In some embodiments, the guide elements 124 are positioned within the pick site 106 such that a pallet positioned within the pick site 106 has a clearance of between about 0.5 inches to about 2.0 inches from the guide elements 124.

In some embodiments, each pick site 106 includes a detection sensor 126 positioned proximate the distal end of the pick site 106 and configured to determine whether a stack 10 of packages 12 is positioned therein. For example, a detection sensor 126 may be coupled to at least one of the guide elements 124 of each pick site 106 proximate the distal end such that when a stack 10 is positioned within the pick site 106 the detection sensor 126 may detect the presence of the stack 10. In some embodiments, the detection sensors 126 are in communication with the industrial control server 114 and may transmit an indication to the industrial control server 114 as to whether a stack 10 is positioned within a work cell 102. The detection sensors 126 may be any one of, but are not limited to, proximity sensors, ultrasonic sensors, capacitive sensors, photoelectric sensors, inductive sensors, or magnetic sensors.

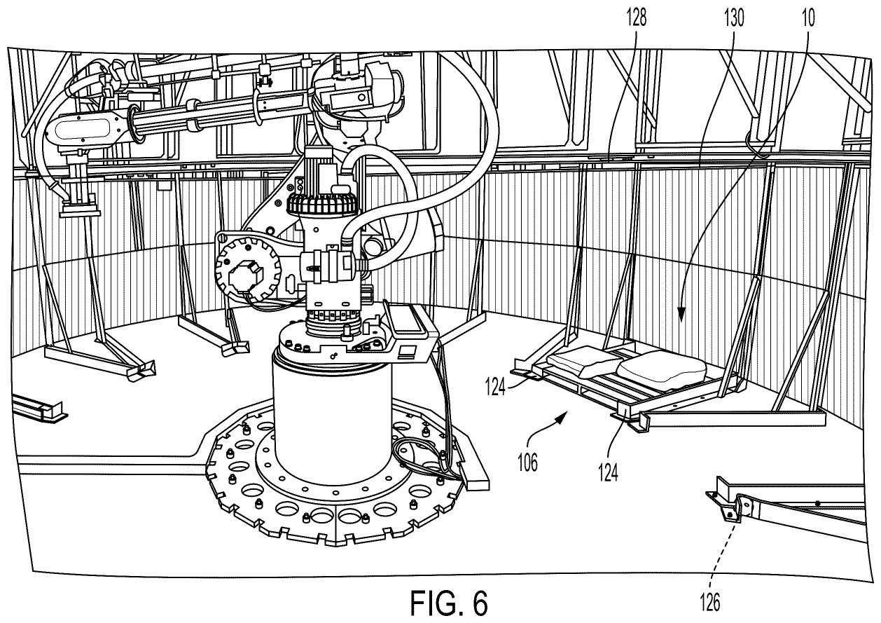

Referring to FIGS. 6-8, there may be a safety wall 128 surrounding the work cell 102 including one or more access doors 130 for moving stacks 10 in and out of the work cell 102. The safety wall 128 may extend around a periphery of the work cell 102 and may prevent personnel from inadvertently entering within the work cell 102 while the robotic arm 104 is activated. In some embodiments, there is an access door 130 at a proximal end of each pick site 106 opposite the robotic arm 104 to enable personnel to remove pallets from an empty stack 10 from a pick site 106 and move new stacks 10 into the pick site 106. In some embodiments, the industrial control server 114 is configured to determine whether any of the access doors 130 are open and in response to detecting that an access door 130 is open prevent movement of the robotic arm 104.

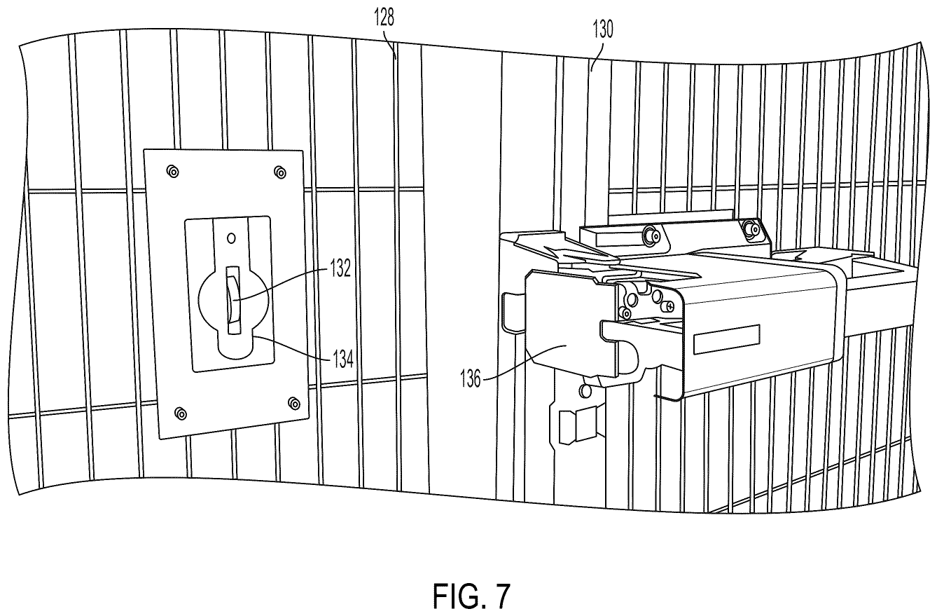

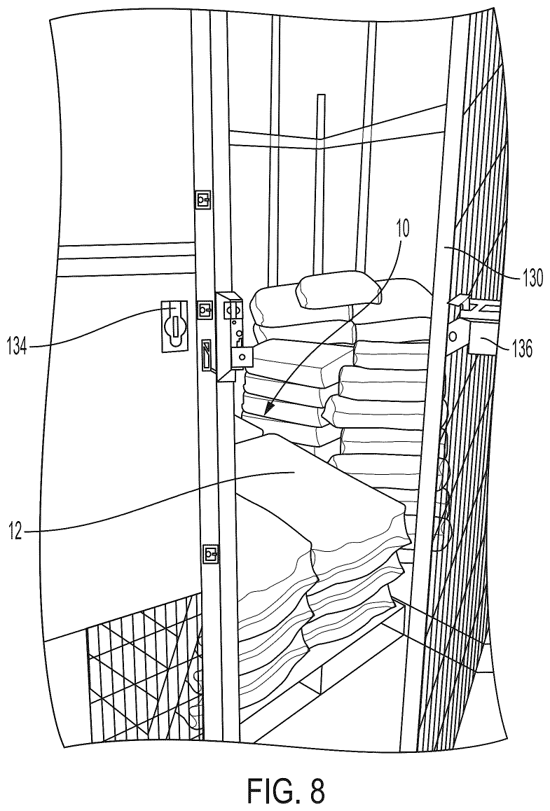

For example, each access door 130 includes an access key 132 and corresponding key slot 134 in communication with the industrial control server 114, as shown in FIG. 7. In some embodiments, the access key 132 is a radio-frequency identification (RFID) key and the corresponding key slot 134 includes an RFID reader. In instances where a stack 10 is to be moved in or out of the work cell 102, personnel may remove the access key 132 from the key slot 134. In response to the access key 132 being removed from the key slot 134, the industrial control server 114 may be configured to receive a request to unlock the corresponding access door 130. Additionally, in instances where the robotic arm 104 is activated when the access key 132 is removed, the industrial control server 114 may cause the robotic arm 104 to finish any current movement and return to the initial position. In response to the robotic arm 104 returning to the initial position, the industrial control server 114 may cause a corresponding magnetic lock coupled to the access door 130 and safety wall 128 to transition from a locked state to an unlocked state thereby allowing the access door 130 to be opened (as shown in FIG. 8).

In response to a detection that the access door 130 being open, the industrial control server 114 may prevent the robotic arm 104 from being activated such that the robotic arm 104 does not move while personnel may be within the work cell 102. In some embodiments, preventing the robotic arm 104 from being activated includes, at the industrial control server 104, setting the robotic arm 104 to a locked state to prevent any movement of the robotic arm 104. As such, personnel may move a stack 10 into or out of the work cell 102 safely. After the personnel have completed their activity within the work cell (e.g., the moving of stacks 10 in or out of the work cell), the personnel may shut the access door 130 thereby causing the magnetic lock 136 to automatically transition from the unlocked state back to the locked state and reinsert the access key 132 into the corresponding key slot 134. The industrial control server 114 may be configured to, in response to determining that the access door 130 is shut, magnetic lock 136 is in the locked state, and that the access key 132 is received within the key slot 134, reactivate the robotic arm 104 (e.g., setting the robotic arm 104 to an unlocked state). As such, a stock of packages 12 may be replenished in the work cell 102, empty pallets may be removed, and/or any necessary maintenance activities may be performed safely such that the robotic arm 104 may resume the picking and packing of packages 12.

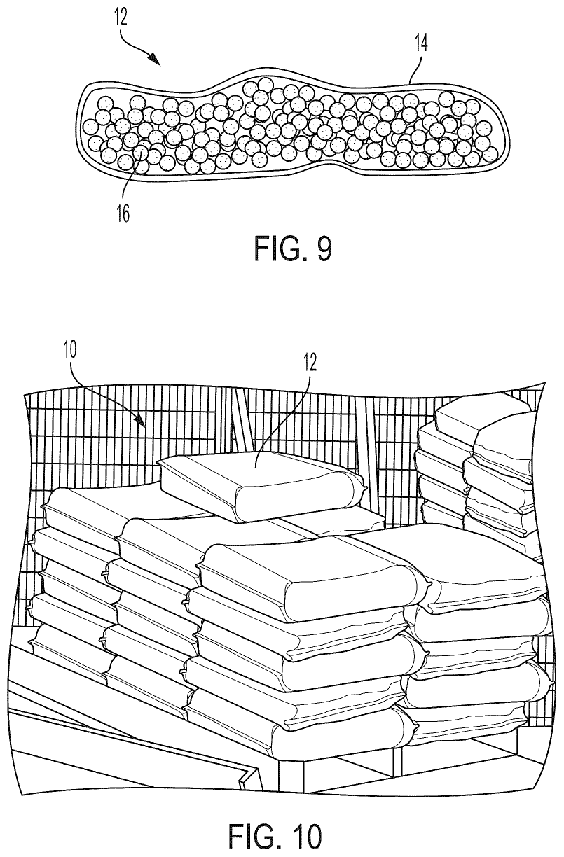

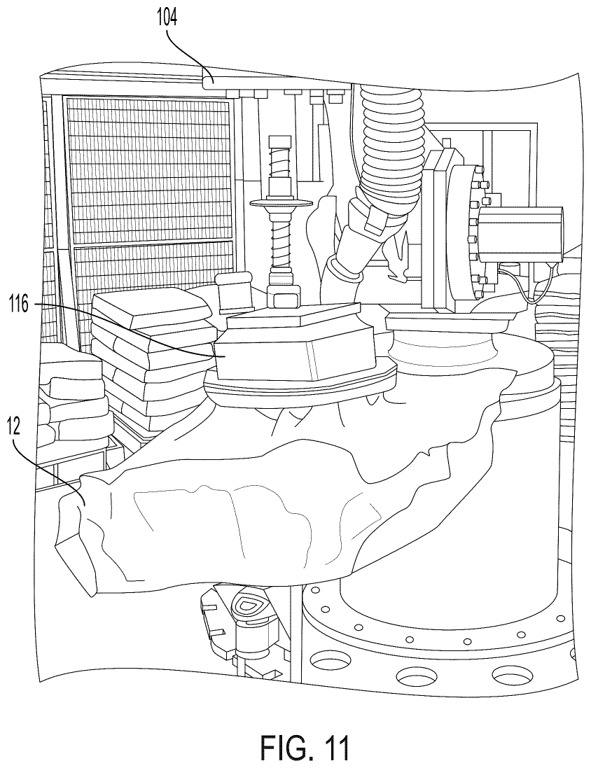

Referring to FIGS. 9-11, and as discussed above, the robotic pack station 100 of the present disclosure is configured to pick and pack packages 12 that are flexible. Each package 12 may comprise a flexible outer film 14 surrounding bulk material 16. The flexible outer film 14 may form a bag containing the bulk material 16 therein. In some embodiments, the flexible outer film 14 is comprised of a plastic material. In some embodiments, the flexible outer film 14 is comprised of, for example, one or more of polyester (PET), polyethylene (PE) and/or a metalized-polyester (MET PET). The bulk material 16 may engage the flexible outer film 14 to conform the package 12 into a first shape when in an unpicked configuration (shown in FIG. 10) and into a second shape when in a picked configuration (shown in FIG. 11). The unpicked configuration may refer to instances where the package 12 is resting on a surface, such as, for example, a pallet, a stationary surface (e.g., the ground), or the surface of an adjacent package 12 in a stack 10. The picked configuration may refer to instances where a force is exerted on the package 12 to lift or hoist the package 12 from its resting position (e.g., when the package 12 is picked by the robotic arm 104).

The bulk material 16 may be generally free to move relative to, and within the flexible outer film 14 such that the shape of the flexible outer film 14 may change in shape when forces exerted on the package 12 change. The bulk material 16 contained within the flexible outer film 14 may not be fixedly coupled to the flexible outer film 14. As such, the bulk material 16 may shift or move within the flexible outer film 14 when forces acting on the bulk material 16 and/or flexible outer film 14 change. For example, the bulk material 16 may be a dry dog food formed into a plurality of pellets and contained within a flexible, deformable bag formed by the flexible outer film 14. In FIG. 10, each package 12 is illustrated in the unpicked configuration where the forces acting on any one package 12 include, generally, the downward force of gravity and an upward force exerted on the bottom package 12 by the surface upon which it rests (e.g., an adjacent package 12, a pallet, the floor). The packages 12 when in the unpicked configuration may be substantially stationary.

In the picked configuration shown in, for example, FIG. 11, a force is exerted on the package 12 by the robotic arm 104 that lifts the package 12 off of the surface upon which it was resting. As such, there is an upward force exerted by the robotic arm 104 on an upper surface of the flexible outer package 14 while the downward gravitational force acts on the flexible outer package 14 and the bulk material 16 contained therein. In this example, the flexible nature of the film 14 and the forces acting on the bulk material 16 contained therein causes the flexible outer package 14 to change in shape. As such, in some embodiments, a flexible package 12 may be characterized in that it is a package having a flexible outer film containing a material and/or substance that, when moved, deforms or changes in shape due to forces acting upon that material and/or substance. In some embodiments, the flexible outer film 14 may include perforations.

In some embodiments, the surface area of the flexible outer film 14 may remain substantially the same when in different shapes. For example, the flexible outer film 14 may not stretch when transitioning from the first shape to the second shape. Although the change in shape of a package 12 is described with reference to a first shape and second shape that are different from one another, it should be understood that the package 12 may change in shape any number of times over the course of time in which the package 12 is picked from a resting position by the robotic arm 104 and placed in a container. Furthermore, different packages 12 may change in shape in different ways. For example, different packages 12, even those that are substantially the same, may change in shape when retrieved (e.g., picked up) by the robotic arm 104 in different ways. As such, in some embodiments, an aspect of the flexible packages 12 may be that the packages 12 change in shape in a somewhat unpredictable manner after being retrieved by the robotic arm 104.

Furthermore, in instances where there are a plurality of different packages 12 having different dimensions and/or containing different weights or volumes of different bulk material, there may be a larger variance in shape change during retrieval by the robotic arm 104 when compared to packages 12 that are generally the same. The work cell 102 may include a plurality of packages 12 arranged in stacks 10 at different pick sites 106. One or more of those pick sites 106 may have stored therein a package 12 that is different from another package 12 stored at a different pick site 106. For example, one pick site 106 may include a stack 10 of a first package 12 (e.g., a first packaged product) and another pick site 106 may include a stack of a second package 12 (e.g., a second packaged product) that is different from the first. As such, the first and second packages may be different in at least one of weight, shape, size and/or material. One such example of a flexible package 12, and as shown in the figures, is a package of dry pet food (e.g., dog food, cat food) that contains a plurality of pellets of a foodstuff enclosed within a flexible outer film. As such, each pick site 106 may have positioned therein packages of different pet foods.

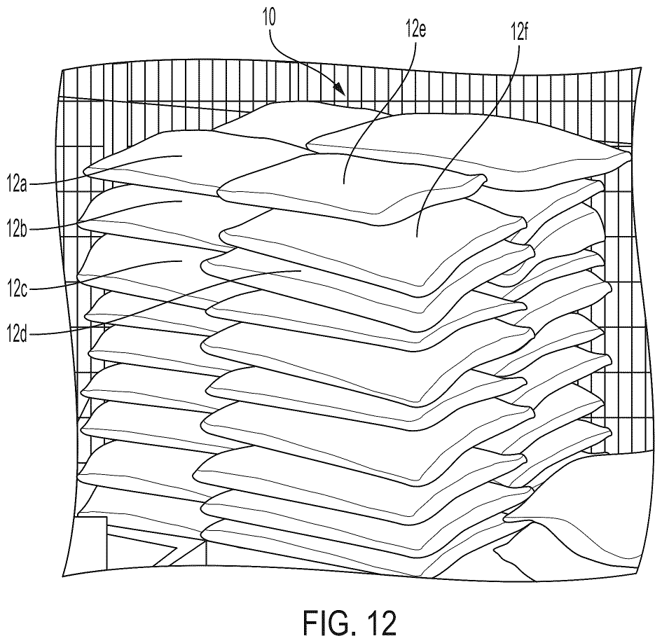

Referring to FIGS. 10 and 12, there may be a plurality of packages 12 arranged in a stack 10 at one or more of the pick sites 106. For example, packages 12 may be stacked one on top of another to form a stack 10. In some embodiments, the packages 12 are arranged in a series of vertically stacked rows where each row includes at least one package 12. For example, and as shown in FIG. 12, there are ten rows of packages 12 stacked one on top of another. Each row may include between three to five packages 12. In some embodiments, the adjacent stacked packages 12 are arranged in an overlapping configuration. For example, in FIG. 12, package 12b positioned within the ninth row from the bottom of the stack 10 overlaps packages 12c and 12d that are positioned within the eight row directly below the ninth row. In some embodiments, the orientation of one or more of the packages 12 may be different from one or more other packages 12. For example, in FIG. 12 package 12a is in a different orientation than the package 12b. The orientation of a package 12 within a stack 10 may refer to the packages 12 orientation in 3-dimensional space.

In some embodiments, packages 12 within a stack 10 may have a shape that is different than the shape of another package 12 within the stack 10. For example, and as illustrated in FIG. 12, the package 12e has a shape different from the package 12f while both are in an unpicked configuration (e.g., while the packages 12e-12f are at rest on the stack 10). In some embodiments, the difference in shape and/or orientation of the packages 12 within a stack 10 are caused, at least partially, by the flexible nature of the packages 12, as discussed above with reference to FIGS. 9-11. As such, the industrial control server 114 may be configured to cause the robotic arm 104 to orient the end effector 116 based on the orientation and/or shape of a package 12 when retrieving that package 12. It should be understood that what is shown in FIG. 12 is an example of a stack 10 and that stacks 10 may include any number of packages 12 stacked one on top of another in any configuration.

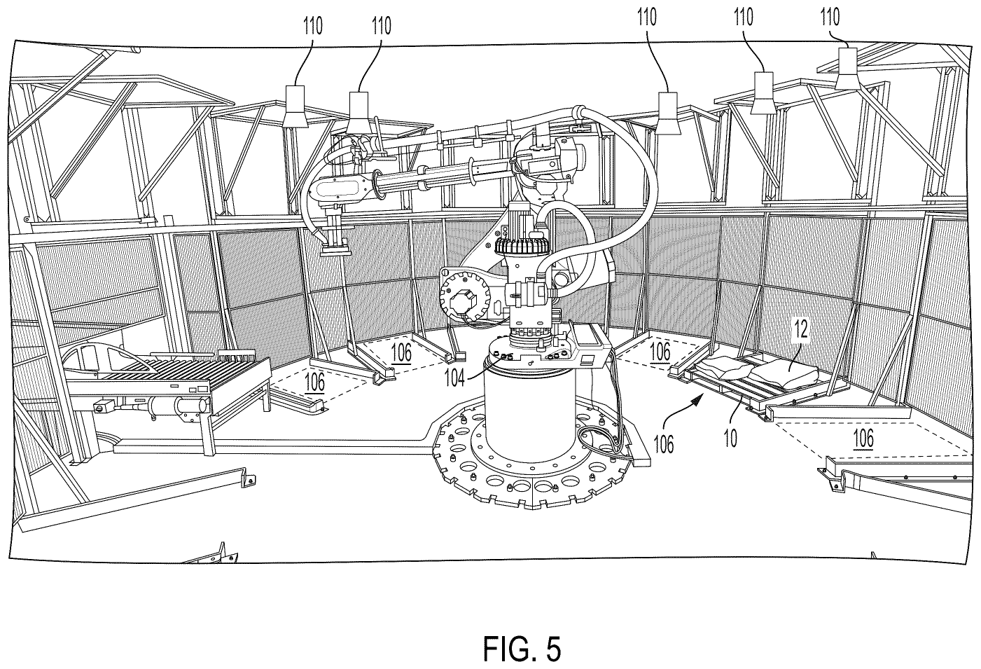

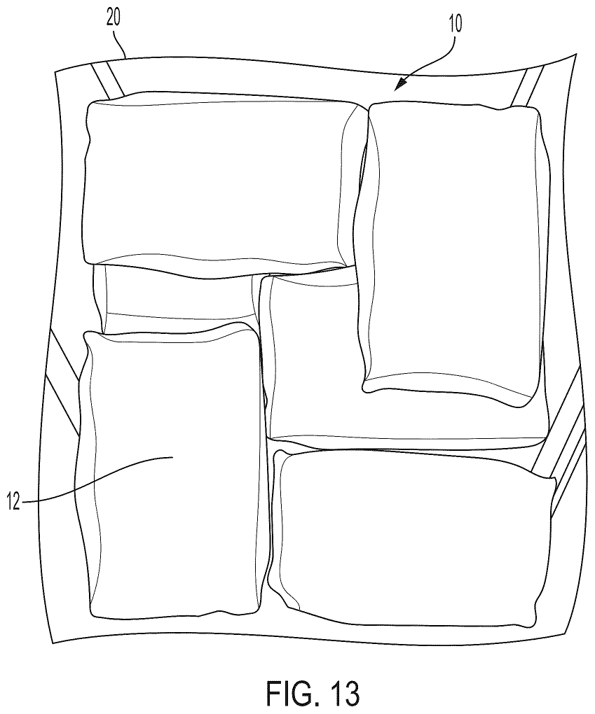

Referring to FIGS. 1, 5 and 13 the image capture system 108 may include a plurality of image capture devices 110. In some embodiments, the image capture system 108 includes at least one image capture device 110 for each pick site 106. As illustrated in FIGS. 1 and 5, there may be an image capture device 110 (e.g., camera) positioned above each pick site 106 such that an image of a stack 10 at any one of the pick sites 106 may be captured. For example, an example image 20 of a stack 10 captured by an image capture device 110 is shown in FIG. 13. As illustrated, the image 20 is captured from a position directly above the stack 10 and as such includes a top-down view of the stack 10. As such, the image 20 may include a visual indication of the position and orientation of packages 12 visible at the top of the stack 10. In some embodiments, each image capture device 110 may be configured to capture a color image of the stack 10. In some embodiments, the position of the image capture devices 110 are fixed relative to the pick sites 106. In some embodiments, each image capture device 110 is positioned at a height above a corresponding pick site 106 such that the entirety of the pick site 106 is within the angle of view of the image capture device 110. The image capture system 108 may transmit the image 20 to the industrial control server 114 such that the control server 114 may effect movement of the robotic arm 104.

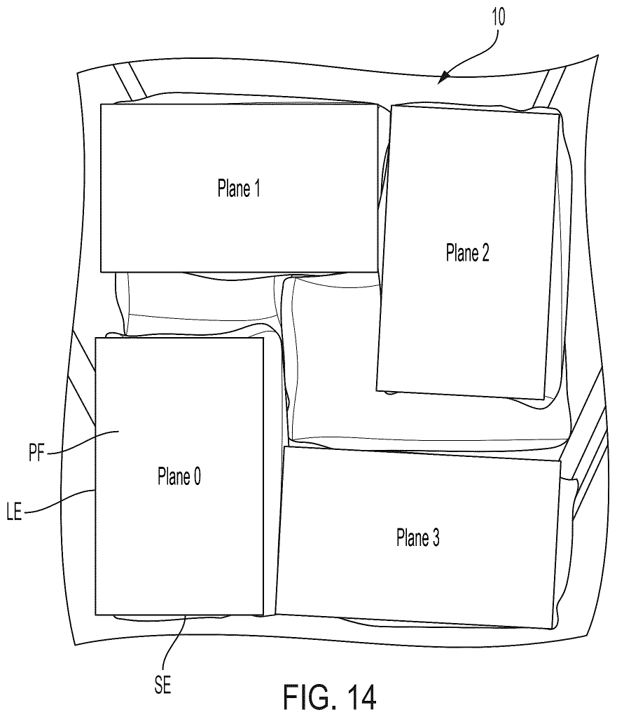

The industrial control server 114 may be configured control movement of the robotic arm 104 based on determined package position information for one or more of the packages 12. In some embodiments, the industrial control server 114 is configured to determine the package position information based on an image (e.g., image 20) received from the image capture system 108. Determining the package position information may include identifying one or more packages 12 on the stack 10. For example, and as shown in FIG. 14, the industrial control server 114 may identify the packages 12 visible at the top of the stack 10. In some embodiments, the industrial control server 114 is configured to leverage a machine learning algorithm trained to identify repeating shapes or patterns such that the industrial control server 114 may identify different packages 12. In FIG. 14, the identification server 114 identifies four different packages 12 visible at the top of the stack 10 based on the image 20.

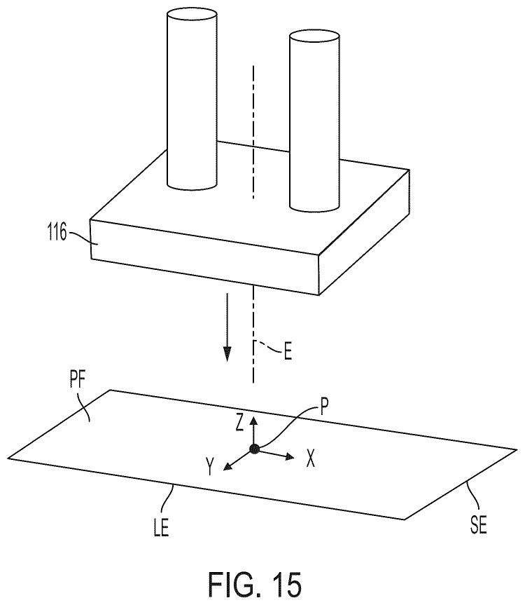

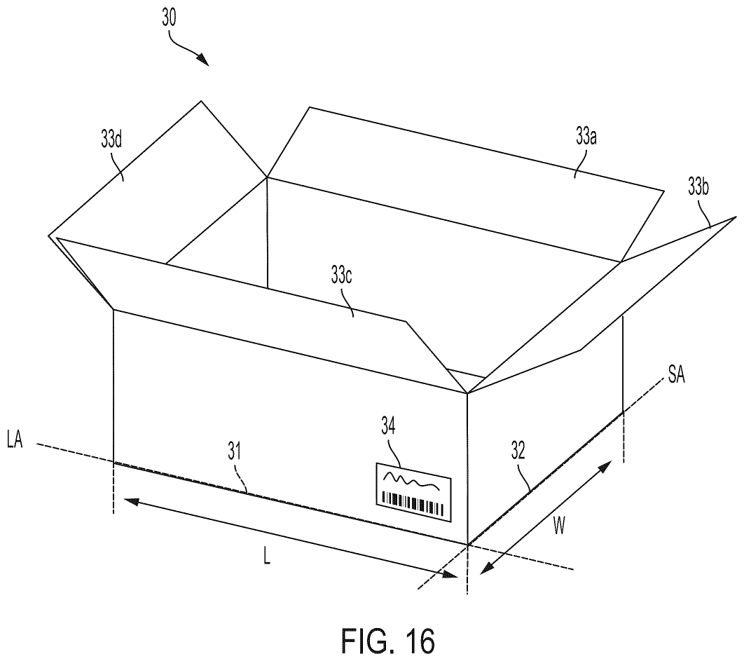

Referring to FIGS. 14-15, in some embodiments, the determined package position information includes a determined package footprint PF of each package 12 on the stack 10. The package footprint PF may be represented as a plane (e.g., planes 0-3 in FIG. 14) extending generally around a periphery of each package 12. In some embodiments, the plane for each package footprint PF is generally rectangular in shape. In other embodiment, one or more of the determined package footprints PF may be irregular in shape. In some embodiments, the determined package footprint PF is at least partially defined by a long edge LE and a short edge SE of the package 12. The industrial control server 114 may be configured to determine the long edge LE and short edge SE based on the determined package footprint PF. For example, the long edge LE may be the longest continuous, or generally linear, line of the footprint PF. The short edge SE may be the shortest continuous, or generally linear line, directly connected to the long edge LE and oriented about 90 degrees relative to the long edge LE.

In some embodiments, the industrial control server 114 is configured to determine which of the identified packages 12 is most optimal for picking based on the image received from the image capture system 108. For example, the industrial control server 114 may determine elevation information of the identified packages 12 and/or whether any of the packages 12 are partially overlapped by an adjacent package 12. For example, in FIG. 14, the industrial control server 114 is configured to determine that the elevation of each of the planes 0-4, where plane 0 is at a higher elevation than plane 1 and so on. Furthermore, the industrial control server 114 may determine that the package 12 corresponding to plane 3 is partially obstructed (e.g., overlapped) by one or more adjacent packages. As such, the industrial control server 114 based on the image 20 may be configured to determine that the package 12 corresponding to plane 0 is the most optimal package 12 to pick from the stack 10.

In some embodiments, in response to identifying the optimal package 12 to pick, the industrial control server 114 may determine orientation information for the package 12. The orientation information may correspond to the packages 12 orientation within a 3-dimensional spaced (e.g., within the work cell 102). In some embodiments, the industrial control server 114 is configured to determine the orientation information based on, at least in part, the image received from the image capture system 108. In some embodiments, the image capture system 108 includes a time-of-flight (ToF) sensor for determining orientation information of packages 12. For example, the image capture system 108 may include one or more ToF light detection and ranging (LIDAR) sensors positioned at each pick site 106. In this manner, the ToF LIDAR sensor may transmit 3-D time of flight data to the industrial control server 114 and the industrial control server 114 may be configured to determine the orientation information for a package 12 based on the received 3-D time of flight data.

In some embodiments, the industrial control server 114 is configured to determine a pick point P for the package 12 to be retrieved by the robotic arm 104. The pick point P may be the point at which the end effector 116 should be centered when retrieving the package 12. For example, the pick point P may be located generally at the geometric center of a package 12. The pick point P may be a point that is generally at the center of the package 12. For example, the pick point P may be located at the intersection of two axes X and Y positioned within the same plane and that are normal to a center point of the long edge LE and short edge SE respectively. In some embodiments, the industrial control server 114 is configured to cause the robotic arm 104 to adjust the orientation of the end effector 116 to generally match the orientation of the package 12 before the robotic arm 104 retrieves the package. For example, the industrial control server 114 is configured to cause the robotic arm 104 to reorient the end effector 116 from a first orientation (e.g., shown in FIG. 4) to a second orientation (e.g., shown in FIG. 15) that is generally the same as the orientation of the package 12. In some embodiments, the industrial control server 114 is configured to determine the orientation of the package 12 based on the orientation information. For example, the industrial control server 114 is configured to determine a pick orientation axis Z that is normal to and intersects the axes X and Y based on the orientation information received from the ToF sensor.

In some embodiments, the pick point P may be the origin point of a package specific cartesian coordinate system in 3-dimensional space. For example, and as illustrated in FIG. 14, the pick point P is at the center of axes X, Y, and Z. As such, the pick point P may include information as to the direction of the long edge LE, short edge SE, and orientation of the package 12 in 3-dimensional space. For example, the axis X may be parallel to the determined long edge LE of the package 12. Similarly, the axis Y may be parallel to the determined short edge SE of the package 12. Furthermore, the orientation axis Z may represent the determined orientation of the package 12 in 3-dimensional space. In some embodiments, the orientation axis Z may represent the roll, pitch, and yaw of the package 12 within 3-dimensional space. In some embodiments, the determined pick point P, including information relating to the axes X, Y, and Z may be transmitted to the industrial control server 114 for use when placing a retrieved package 12 into a container (as discussed in more detail below).

In some embodiments, the industrial control server 114 is configured to cause the robotic arm 104 to orient the end effector 116 in the second orientation in which the end effector axis E is generally parallel to the pick orientation axis Z and passes through the pick point P. The industrial control server 114 may be configured to cause the robotic arm 104 to move the end effector 116 while in the second orientation onto the package 12 and activate the end effector 116 such that the package 12 is retrieved by the end effector 116 and can be picked from the stack 10 and moved to a different location. In instances where the end effector 116 is a suction based end effector, causing the robotic arm 104 to reorient the end effector 116 into the second orientation prior to activating the end effector 116 may reduce the risk of the package 12 being dropped during movement. For example, by orienting the end effector 116 into the second orientation may ensure that a seal is formed between the end effector 116 and package 12 such that the package 12 may be reliably picked from the stack 10 while minimizing the risk of the end effector 116 dropping the package 12. In this manner, the industrial control server 114 may be configured to cause the robotic arm 104 to reliably retrieve packages 12 and move retrieved packages 12 into a container.

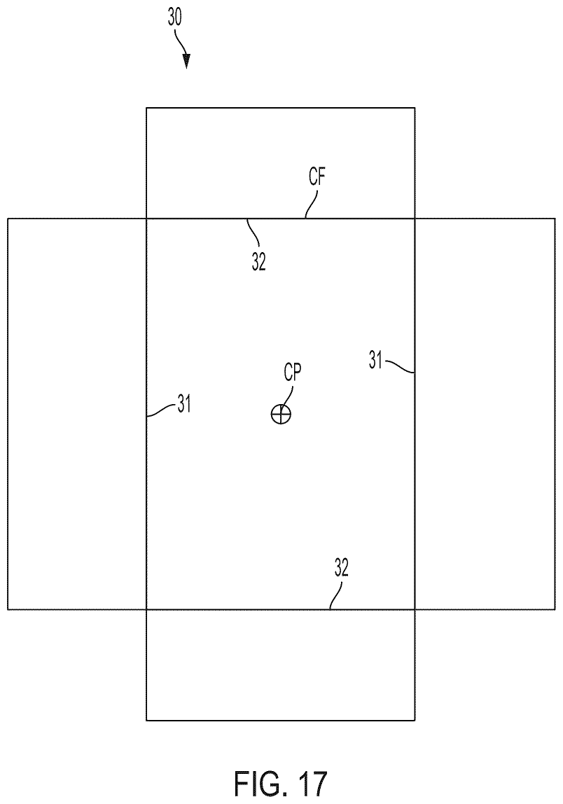

Referring to FIGS. 16-17 there is shown an example of container 30 for receiving a package 12. FIG. 16 is a perspective view of the container 30 and FIG. 17 is a top plan view of the container 30. The container 30 may be a box or other type of container defining an interior cavity or receptacle within which a package 12 may be placed. The containers 30 may be generally rectangular in shape when viewed from the top. In FIGS. 16 and 17, the container 30 is in an open configuration where there is an opening at the top of the container 30 such that a package 12 may pass through the opening and be placed in the container 30. The container 30 may have a container footprint CF as defined by a length L and width W of the container 30. The container footprint CF may be generally rectangular in shape and defined by a bottom surface of the container 30. The container 30 may include a center point CP with respect to the bottom planar surface of the container 30. The center point CP may be the point on the bottom planar surface that is equidistant from opposed edges of the container 30.

The container 30 may have a long edge 31 corresponding to the length L of the container 30 and a short edge 32 corresponding to the width W. In some embodiments, the long edge 31 extends along a long axis LA of the container 30 and the short edge 32 extends along a short axis SA of the container 30. The center point CP may be located equidistant between opposed short edges 32 and opposed long edges 31. In some embodiments, the center point CP may serve as a reference point when placing a package 12 in the container 30 via the robotic arm 104 (as discussed in more detail below). In some embodiments, the container 30 is comprised of a corrugated material (e.g., cardboard). In some embodiments, the container 30 is a regular slotted container (RSC) and is erected with four extended flaps 33a-33d.

In some embodiments, the container 30 may be a shipping container that may be shipped directly to a customer who purchased a packaged product (e.g., package 12). For example, the container 30 may include a label 34 having indicia printed thereon that includes a visual indication associated with a customer's order. For example, the label 34 may include indicia corresponding to the customer's name, mailing address, container contents, a bar-code and/or any other order-specific information useful for shipping the container to the customer. Orders placed by a customer and the order information associated therewith will be discussed in further detail below. However, it should be understood that an order, alternatively referred to as a customer order, generally refers to purchases of one or more specific products placed by a customer that the robotic pack station 100 may be configured to fulfill.

Referring back to FIG. 1, the robotic pack station 100 may be configured to automatically erect containers 30 and apply indicia thereto. The robotic pack station 100 may include a container erector 138 and indicia applicator 140 coupled to the container conveyor 112. The container erector 138 may be configured to erect a container 30 and the indicia applicator 140 may be configured to apply indicia on the erected container 30. The container erector 138 may be positioned upstream of the indicia applicator 140 with respect to the container conveyor 112. In some embodiments, the container erector 138 is configured to erect a container 30, as shown in for example, FIG. 16, from a blank of the container 30. For example, in instances where the containers 30 are cardboard containers, they may be stored in an unassembled, or blank, state wherein the container is generally flat. The container erector 30 may receive the container in the blank configuration and form the blank into a configuration similar to what is shown in FIG. 16 wherein one or more panels of the container 30 are not coplanar with one or more other panels. In some embodiments, the containers in the blank configuration may be stored in the container erector 30 such that the container erector 138. In some embodiments, the container erector 30 is configured to erect containers 30 of different sizes and/or shapes. Tn some embodiments, the container erector 138 may include a store of containers in a blank configuration of different sizes and/or shapes. In some embodiments, the industrial control server 114 is in communication with the container erector 138 and configured to control operation of the container erector 138.

The indicia applicator 140 may be configured to generate and apply indicia to a container 30 erected by the container erector 138. For example, the indicia applicator 140 may include a printing device and a store of adhesive labels. The indicia applicator 140 may print indicia (e.g., visual indications of order information) on the label and adhere the printed label onto an erected container 30. The indicia applicator 140 may be in communication with the industrial control server 114 such that the industrial control server 114 may control the indicia applicator 140. The indicia applicator 140 may be positioned along the container conveyor 112 downstream of the container erector 138. In this manner, the container erector 138 may erect a container 30 and output the erected container 30 onto the container conveyor 112. The container conveyor 112 may transfer the erected container 30 downstream to the indicia applicator 140 such that the indicia applicator 140 may apply indicia to the erected container 30.

Upstream and downstream of the container conveyor 112 refers to the direction that the container conveyor 112 is configured to transport the containers 30. For example, and as illustrated by the arrows on the container conveyor 112 in FIG. 1, the container conveyor 112 may transfer erected containers 30 from the container erector 138 towards the work cell 102. Packages 12 placed in containers 30 by the robotic arm 104 may be transferred out of the work cell 102 by a corresponding conveyor. In some embodiments, the container conveyor 112 includes a plurality of powered rollers configured to, when powered, move containers 30 along the container conveyor 112. In some embodiments, the industrial control server 114 is in communication with the container conveyor 112 and configured to control activation of the container conveyor 112. For example, the industrial control server 114 may be configured to selectively activate and deactivate the powered rollers such that the industrial control server 114 may control movement of containers 30 conveyed thereon. In some embodiments, there may be one or more container detection sensors positioned at different points along the container conveyor 112 and in communication with the industrial control server 114. The container detection sensors may be configured to detect the presence of containers 30 at different points along the container conveyor 112 and transmit the indication to the industrial control server 114.

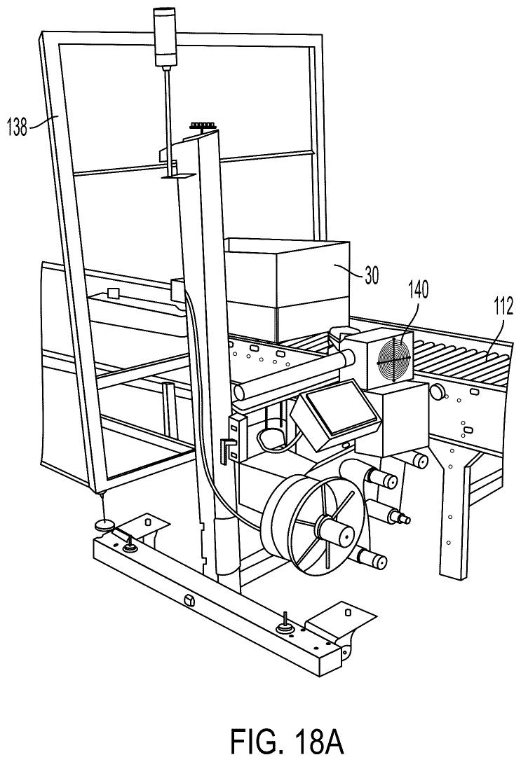

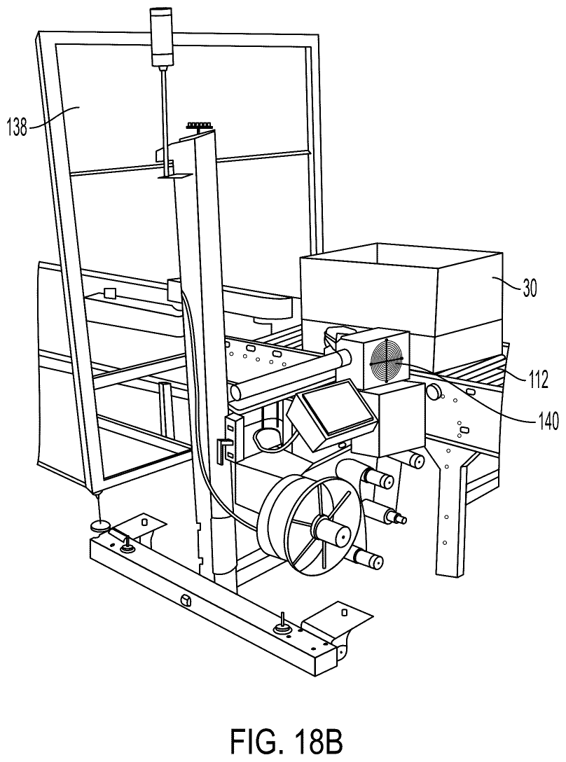

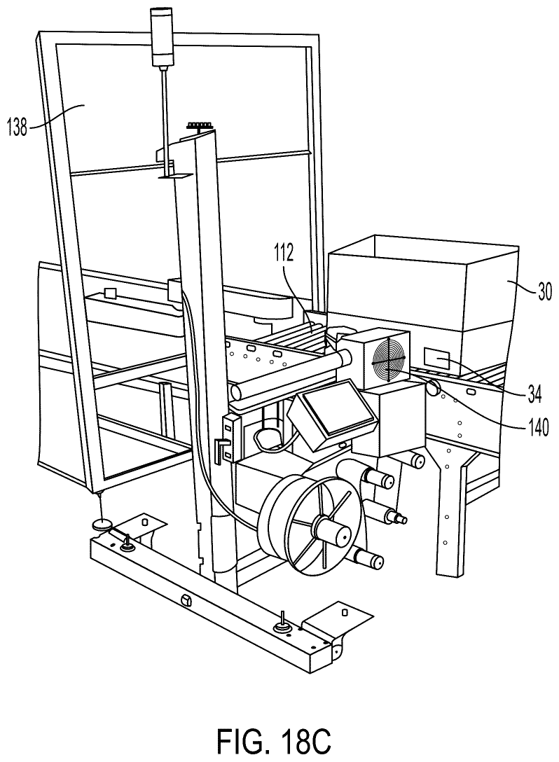

Referring to FIGS. 18A-18C, there is shown an example of a container 30 being output by the container erector 138 onto the container conveyor 112 and transmitted downstream to the indicia applicator 140. In FIG. 18A, the industrial control server 114 is configured to cause the container erector 138 to erect the container 30 and transfer the erected container 30 onto the container conveyor 112. The industrial control server 114 may be further configured to cause the container conveyor 112 to move the erected container 30 along the container conveyor 112 towards the indicia applicator 140. In FIG. 18B, the erected container 30 is positioned on the container conveyor 112 such that a surface of the container 30 is proximate the indicia applicator 140. In some embodiments, the industrial control server 114 is configured to detect that the container 30 is at a position along the container conveyor 30 at which the indicia applicator 140 may apply indicia to the container 30. For example, there may be one or more detection sensors (e.g., proximity sensors) coupled to the indicia applicator 140 and configured to transmit an indication to the industrial control server 114 of the position of the container 30 relative to the indicia applicator 140.

The industrial control server 114 may be configured to cause the indicia applicator 140 to apply indicia to the container 30. In FIG. 18B, the industrial control server 114 may be configured to cause the indicia applicator 140 to apply indicia to the container 30 in response to the container 30 being positioned proximate the indicia applicator 140. The container 30 being proximate the indicia applicator 140 may refer to a position of the container 30 being within an operating range of the indicia applicator 140. The operating range of the indicia applicator 140 may be the range within which the indicia applicator 140 may apply indicia to a surface. In FIG. 18C, the indicia applicator 140 has successfully applied indicia to the container 30 and the industrial control server 114 causes the container 30 to be transferred further downstream on the container conveyor 112. For example, in FIG. 18C, it can be seen that a label 34 has been applied to the container 30 by the indicia applicator 140 and that the container 30 has been transferred further downstream by the container conveyor 112.

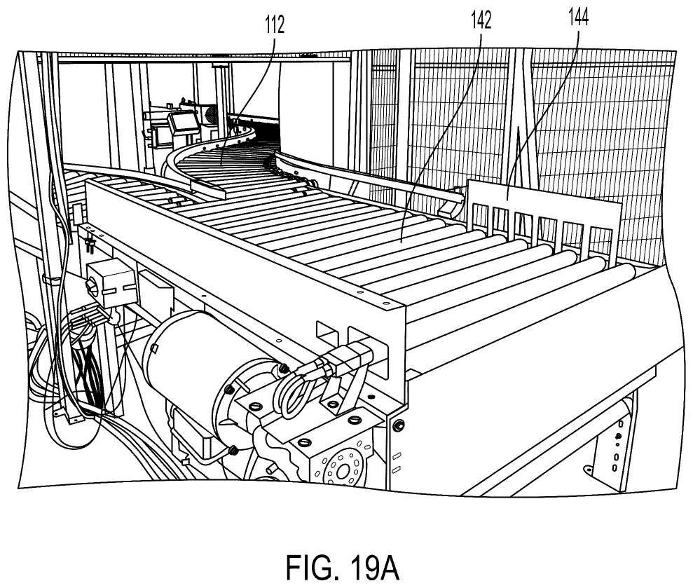

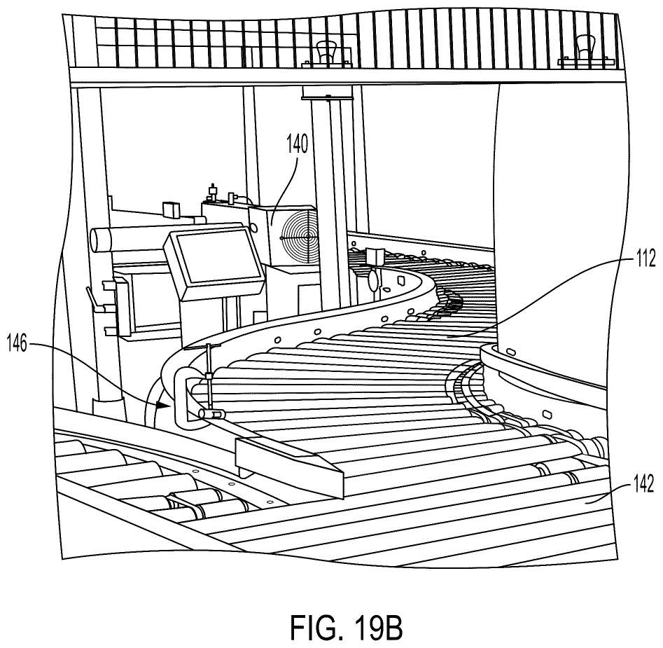

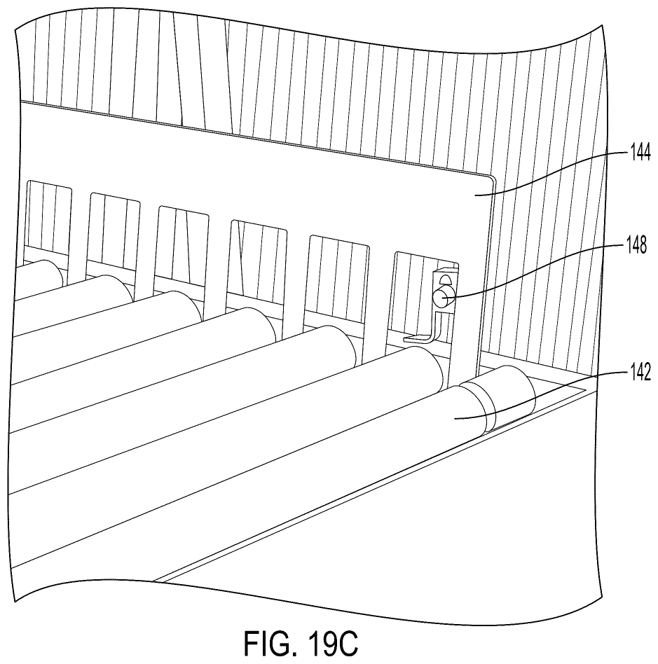

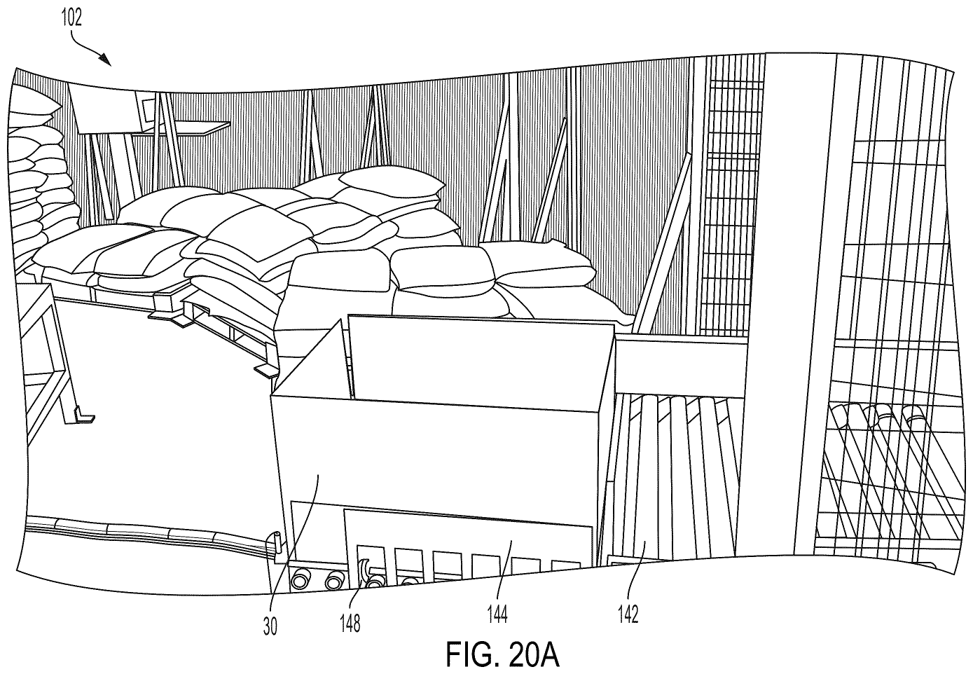

Referring to FIGS. 1 and 19A-19C, the robotic pack station 100 may include a transfer table 142 positioned within the work cell 102 and coupled to the container conveyor 112. The transfer table 142 may be configured to position a container 30 within the work cell 102 at a predetermined position within the work cell 102, as discussed in more detail below. The transfer table 142 may include a plurality of powered rollers configured to be selectively rotated in a clockwise and/or counter-clockwise direction. As such, the transfer table 142 may be configured to displace containers 30 towards and/or away from the container conveyor 112. In some embodiments, the industrial control server 114 is configured to control the rotation of the powered rollers of the transfer table 142. For example, the industrial control server 114 may be configured to transmit signals to the transfer table 142 to cause the powered rollers to rotate in a clockwise and/or counter-clockwise direction. In some embodiments, the transfer table 142 is coupled to the container conveyor 112 such that containers 30 may be transferred from the container conveyor 112 and onto the transfer table 142. The transfer table 142 may be positioned within the work cell 102 and within a range of motion of the robotic arm 104.

In some embodiments, the transfer table 142 includes a displacement rake 144 in communication with the industrial control server 114. The displacement rake 144 may be configured to position a container 30 to be packed at a predetermined location on the transfer table 142. In some embodiments, the displacement rake 144 is comprised of a generally rigid material (e.g., a metal). In some embodiments, the displacement rake 144 is configured to translate relative to the transfer table 142. The displacement rake 144 may be powered by a motor or engine positioned under the transfer table 142 coupled to the displacement rake 144. The displacement rake 144 may extend upwardly from the transfer table 144 such that it may abut a sidewall of a container 30 during translation of the displacement rake 144 thereby causing the container 30 to be moved relative to the transfer table 144.

In some embodiments, there is a first container sensor 146 (see FIG. 19B) coupled to the container conveyor 112 and positioned between the indicia applicator 140 and the transfer table 142. The first container sensor 146 may be configured to determine whether there is a container 30 positioned on the container conveyor 112 to be moved onto the transfer table 142. For example, the first container sensor 146 may be in communication with the industrial control server 114 and may transmit an indication to the industrial control server 114 that a container 30 is detected proximate the location of the first container sensor 146. The industrial control server 114 may receive an indication from the first container sensor 146 that there is a container 30 waiting to be moved onto the transfer table 142. In some embodiments, the first container sensor 146 includes a proximity sensor and/or a barcode scanner. In this manner, the first container sensor 146 may be configured to determine the proximity of a container 30 relative to the sensor 146 and/or scan a barcode printed on a label 34 of the container 30. The first container sensor 146 may transmit barcode data to the industrial control server 114 and the industrial control server 114 may be configured to determine which order is associated with the container 30 based on the barcode data.

In some embodiments, there may be a second container sensor 148 (see FIG. 19C) coupled to the transfer table 142 and configured to detect the position of a container 30 on the transfer table 142. The second container sensor 148 may be positioned proximate a distal end of the transfer table 142. In some embodiments, the second container sensor 148 is a proximity sensor, or any other suitable sensor for detecting the presence of the container 30. The second container sensor 148 may be in communication with the industrial control server 114. In some embodiments, in response to detecting a position of the container 30 on the transfer table 142 the second container sensor 148 may transmit an indication to the industrial control server 114 that the container 30 is detected. The industrial control server 114 in response to receiving the indication from the second container sensor 148 may cause the displacement rake 144 to translate relative to the transfer table 142 thereby displacing the container 30 relative to the transfer table 142.

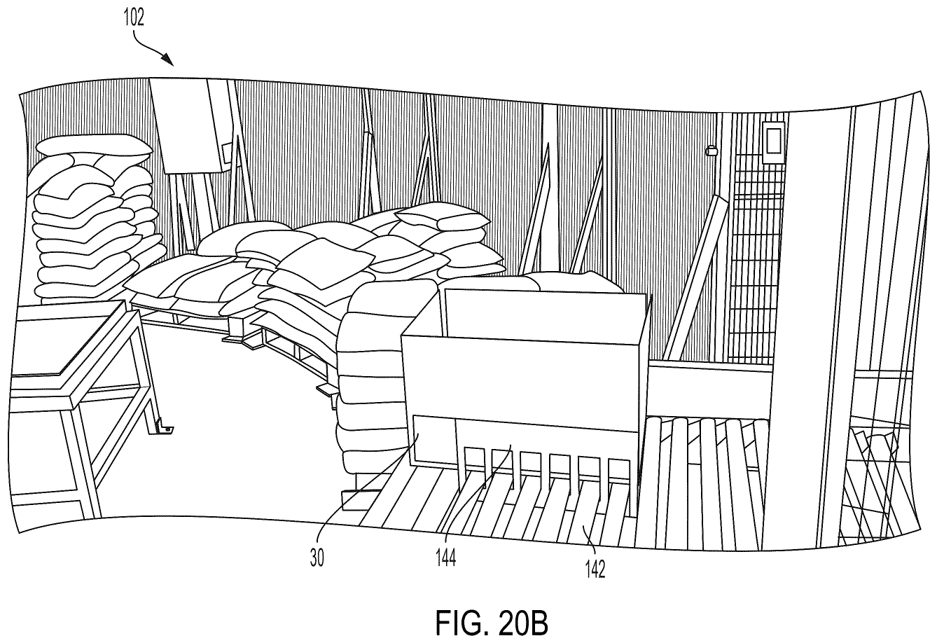

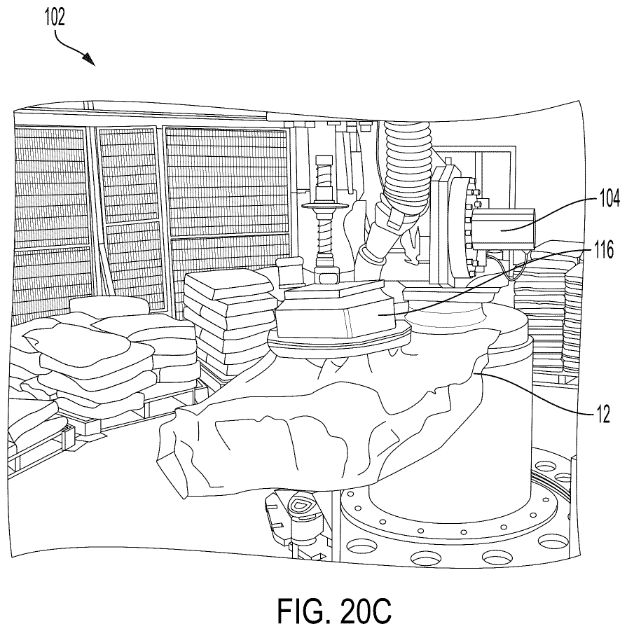

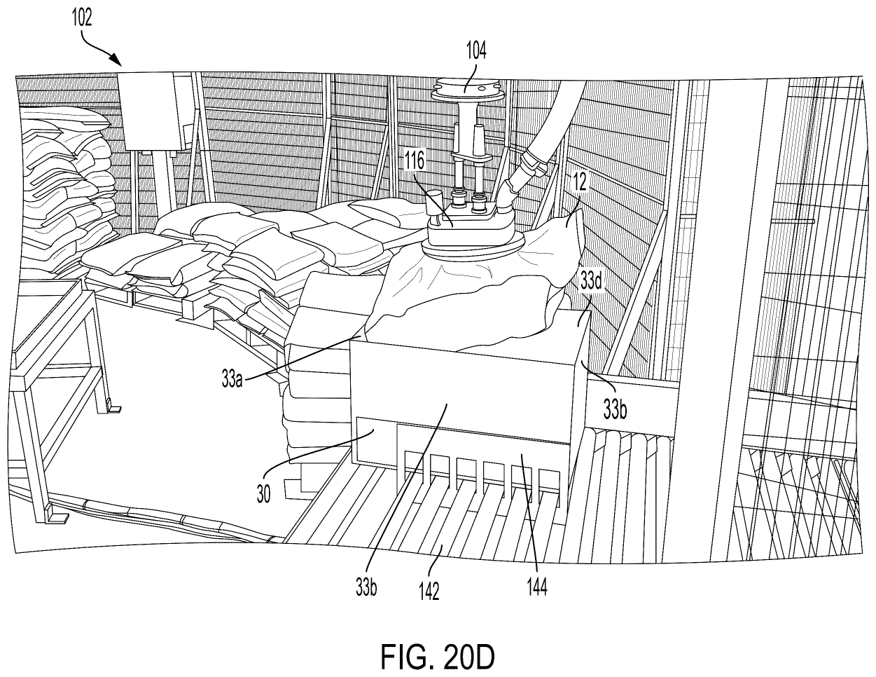

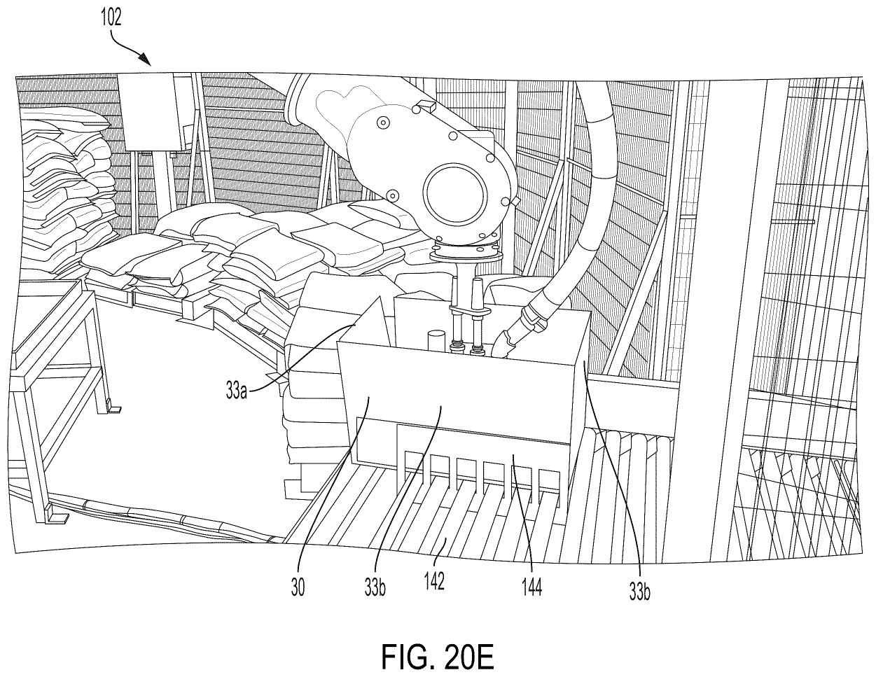

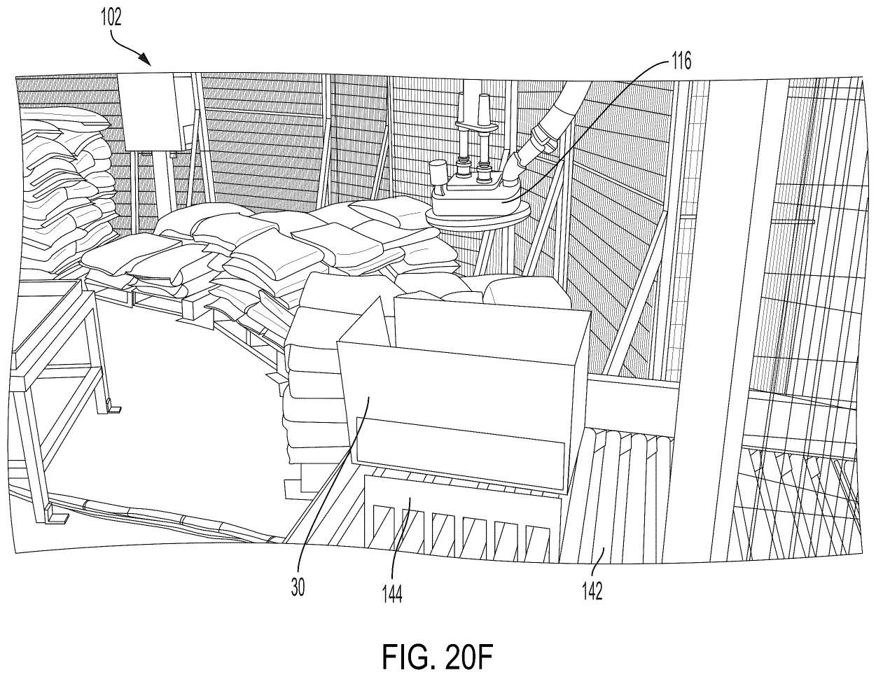

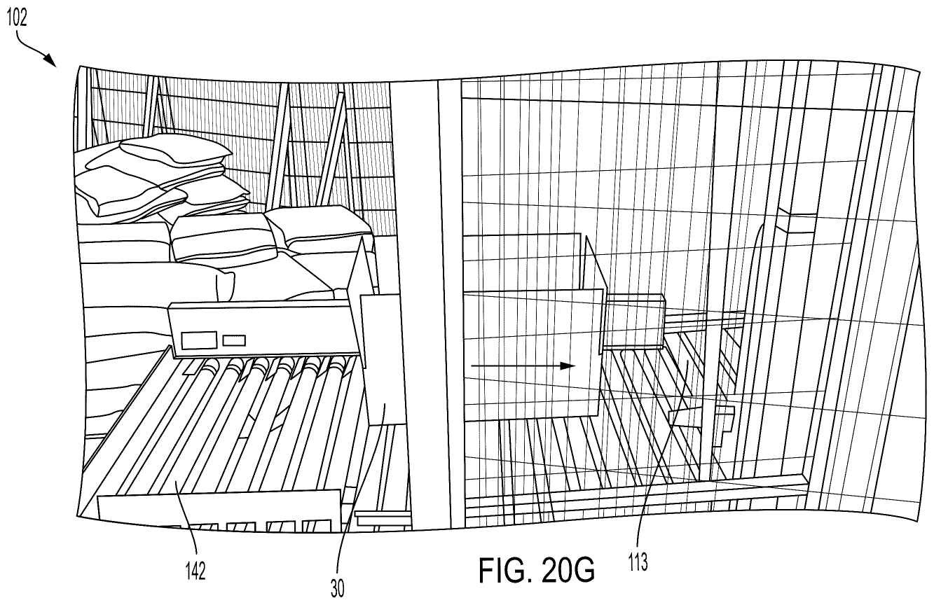

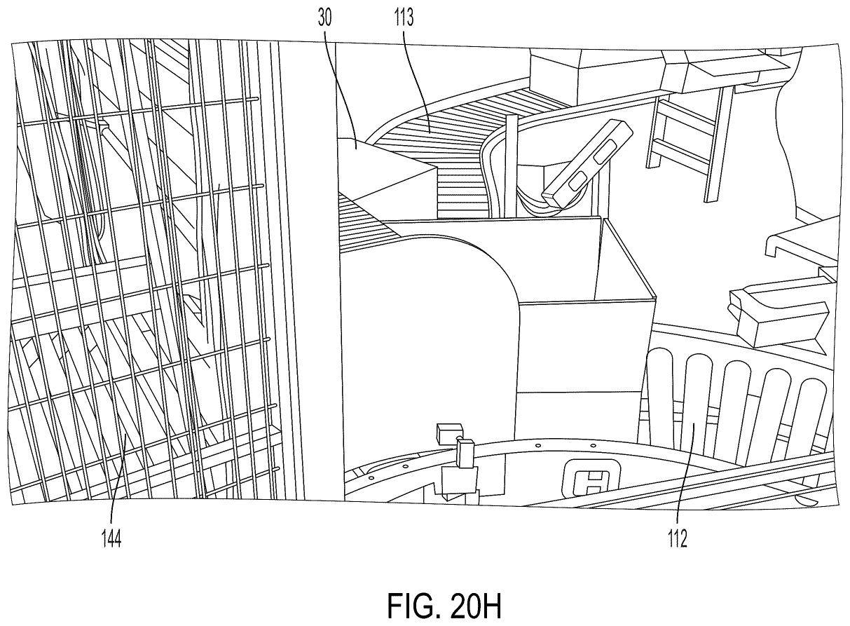

For example, and referring to FIGS. 20A-20B, a container 30 being moved by the displacement rake 144 is shown. As illustrated in FIG. 20A, the container 30 has been moved along the transfer table 142 by the powered rollers such that the container 30 abuts the distal end of the transfer table 142. The second container sensor 148 may be configured to detect the container 30 and transmit an indication of the container 30 position to the industrial control server 114. In response to receiving the indication from the second container sensor 148, the industrial control server 114 may be configured to position the container 30 in a retained position as shown in FIG. 20B. For example, the industrial control server 114 may be configured to cause the displacement rake 144 to translate from a first position (shown in FIG. 20A) to a second position (shown in FIG. 20B) such that the container 30 is moved to the retained position. The retained position may refer to a predetermined position for the container 30 on the transfer table 142 at which a package 12 picked by the robotic arm 104 is to be placed therein.

Different containers 30 may be retained in generally the same position on the transfer table 142 when a package 12 is being placed therein by the robotic arm 104. For example, and as discussed above, each container 30 has a container center point CP (see FIG. 17) and by positioning containers 30 in the retained position, the container center point CP may be in generally the same location within the work cell 102 each time a package 12 is to be placed therein. In some embodiments, the industrial control server 114 is configured to cause the displacement rake 144 to remain in the second position (e.g., as shown in FIG. 20B) until a package 12 is placed within the container 30. The displacement rake 144 may restrict movement of the container 30 in at least one direction during placement of a package 12 therein.

Referring now to FIGS. 20C-20H, there is shown an example of a package 12 being placed into a container 30 by the robotic arm 104. In FIG. 20C, the industrial control server 114 has caused the robotic arm 104 to retrieve (e.g., pick) a package 12 via the end effector 116. The package 12 in FIG. 20C is shown in a second shape in the picked configuration that may be different than the shape of the package 12 when resting on a corresponding stack 10 (not shown). In FIG. 20D, the industrial control server 114 has caused the robotic arm 104 to orient the package 12 relative to the container 30 for placement therein. As discussed above, the container 30 may be in the retained position (shown in FIG. 20D) during placement of a package 12 therein.

In some embodiments, orienting the package 12 relative to the container 30 for placement therein includes aligning the long and short edges LE, SE and pick point P of the package 12 with the long and short axes LA, SA and center point CP of the container 30 (shown in FIGS. 15-17). For example, the industrial control server 114 may be configured to cause the robotic arm 104 to position the package 12 above the container 30 such that the long and short edges LE, SE of the package 12 are generally parallel with the long axis LA and short axis SA of the container 30 and such that the pick point P of the package 12 is directly above the center point CP of the container 30 (as shown in FIG. 20D). Alternatively, the industrial control server 114 may be configured to cause the robotic arm 104 to position the package 12 above the container 30 such that the X and Y axes (shown in FIG. 15) are parallel with the long and short axes LA, SA of the container 30 and such that the pick point P is directly above the center point CP. When the long and short edges LE, SE of the package are aligned with the long and short axes LA, SA of the container 30 and the pick point P is directly above the center point of the container 30, the package 12 may be in a placement orientation. In some embodiments, the industrial control server 114 is configured to cause the robotic arm 104 to move the package 12 into the placement orientation with an accuracy of at least 3/1000 of an inch. Similarly, the industrial control server 114 may be configured to place the package 12 within the container 30 such that the pick point P of the package 12, when placed within the container 30, is directly above the center point CP of the container with a tolerance of at least 3/1000 of an inch.

In some embodiments, the industrial control server 114 is configured to place a package 12 within a container 30 having a smaller footprint than the package 12. For example, one or more of the packages 12 within a stack 10 at any one of the pick sites 106 may have a package footprint PF (illustrated in FIG. 15) that is greater than the container footprint CP (illustrated in FIG. 17) of a container 30 to which the package 12 is to be placed. In some embodiments, the industrial control server 114 may achieve placement of the package 12 within the container 30 having a smaller footprint by causing the robotic arm 104 to orient the package 12 in the placement orientation as described in the preceding paragraph. In some embodiments, the industrial control server 114 may be configured to achieve placement in such an instance at least in part due to the flexible nature of the package 12 in combination with causing the robotic arm 104 to orient the package 12 into the placement orientation.

In some embodiments, the container 30 may have a footprint that is smaller than a package 12 and a container volume that is greater than or equal to a volume of the package 12. Packages 12 may be generally deformable, as discussed above, however each may have a volume that is generally the same regardless of how the package 12 is deformed. The container volume of a container 30 may be fixed. In some embodiments, by providing containers having a container volume that is generally equal to or greater than a volume of the package 12, the industrial control server 114 may be configured to place a package 12 within a container 30 in instances where the package footprint is greater than the container footprint 30. In some embodiments, the container volume is between about 5% to about 20% greater than a volume of a package 12 placed therein. In other embodiments, the container volume is between about 1% to about 5% greater than a volume of a package 12 placed therein.

In some embodiments, the industrial control server 114 is configured to cause the robotic arm 104 to place a package 12 into the container 30, while in the retained position (e.g., shown in FIG. 20D) without folding one or more of the flaps 33a-33d of the container 30. For example, and as shown in FIG. 20D, the flaps 33a-33d of the package 30 are in an unfolded configuration in which they do not cover the opening of the container 30. In FIG. 20E as the package 12 is placed within the container 30 it can be seen that the flap 33a deflects away from the opening of the container 30 and/or the other flaps 33b-33d slightly. Although the flap 33a deflects away from the container 30 in FIG. 20E, the flap 33a has not been folded over towards the opening of the container 30. The deflection of the flap 33a may not negatively impact the placement of the package 12 within the container 30. In other instances, the flaps 33a-33d may remain substantially fixed while the package 12 is placed within the container 30.

In some embodiments, following placement of the package 12 within the container, the industrial control server 114 may be configured to cause the end effector 116 to be deactivated thereby decoupling the package 12 from the end effector 116. The industrial control server 114 may be configured to cause the displacement rake 144 to translate relative to the transfer table 142 such that the displacement rake 144 no longer abuts the container 30. For example, and as shown in FIG. 20F, the end effector 116 is shown above the container 30 containing package 12 following placement of the package 12 in FIG. 20F and the displacement rake 144 no longer abuts the container 30.

In some embodiments, the industrial control server 114 may cause the transfer table 144 to move the container 30 having package 12 placed therein out of the work cell 102. For example, the industrial control server 114 may cause the powered rollers of the transfer table to rotate in a direction causing the container 30 to be moved away from the work cell 102 towards a second container conveyor 113. FIGS. 20G-20H shown an example of the packed container 30 being moved out of the work cell 102 and onto the second container conveyor 113, while another container is positioned on the container conveyor 112 to be moved onto the transfer table 142 for placement of another package 12.

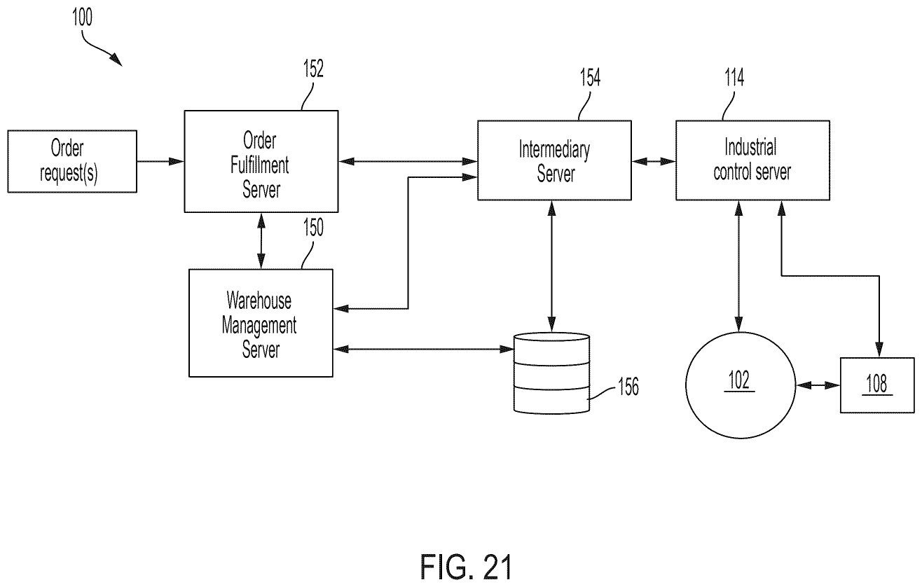

Referring to FIG. 21, there is shown a system diagram of the robotic pack station 100 illustrating the coupling of various exemplary servers and/or system configured to receive purchase order requests for packaged products and automatically pick and pack the products for shipment to a customer. Some components or elements of the robotic pack station shown in, for example, FIG. 1 are not depicted in FIG. 21 so as not to clutter the figure, however it should be understood that the robotic pack station 100 includes those components discussed above. As discussed above, the robotic pack station 100 pick packages 12 from stacks 10 positioned within the work cell 102 in accordance with order requests for those packages 12. The robotic pack station 100 may be configured to automatically perform the picking and packing of packages 12 based on one or more received order requests. The order requests may be generated at a customer facing user interface (not shown), such as, but not limited to, an online storefront. The order requests may be for one or more specific products and/or packages offered for sale at the online storefront.

In some embodiments, the robotic pack station 100 includes a warehouse management server 150, an order fulfillment server 152, an intermediary server 154 and a database 156 storing product-specific information therein. The warehouse management server 150 may be configured to store and maintain product inventory records for a plurality of different products offered for sale at the online storefront. The order fulfillment server 152 may be in communication with the online storefront and configured to receive order requests for a plurality of different products. In some embodiments, the warehouse management server 150 and order fulfillment server 152 are in communication with one another. The intermediary server 154 may be configured to facilitate communication between the servers 150, 152, 114. The intermediary server 154 may be in communication with the order fulfillment server 152, warehouse management server 150 and/or the industrial control server 114. The database 156 may store product-specific information for the plurality of products offered for sale at the online storefront and may be in communication with one or more of servers 150, 152, and 154.

In some embodiments, the order fulfillment server 152 is in communication with the industrial control server 114 and configured to transmit instructions to the industrial control server 114 to cause the robotic arm 104 to retrieve one or more packages containing requested products for placement in a container. For example, the order fulfillment server 152 may be configured to receive one or more order requests and transmit one or more corresponding product requests to the warehouse management server 150. In some embodiments, the order fulfillment server is configured to receive a plurality of order requests and transmit a corresponding plurality of product requests to the warehouse management server 150. The warehouse management server 150 may be configured to retrieve product-specific information corresponding to the one or more product requests from the database 156. For example, the product requests may include an indication as to one or more requested products and the warehouse management server 156 may be configured to query or search the database 156 for product-specific information corresponding to the requested products.

In some embodiments, the warehouse management server 156 and/or order fulfillment server 152 may be configured to generate order-specific information based on the retrieved product-specific information and the received order request. For example, the order request may include information such as, but not limited to, a unique order identifier (e.g., order number), product identify information, order priority information, and shipping information (e.g., customer name, address). The product-specific information retrieved from the database 156 may include, but is not limited to, product identity information, container size information, and designated pick site information. The order-specific information generated for each of a plurality of order requests may include at least one of i) product identity information, ii) container size information, iii) order identifier information, iv) shipping information, v) order priority information, and vi) designated pick site information.

In some embodiments, the intermediary server 154 may be configured to receive order-specific information for a plurality of pending orders from the warehouse management server 150 and/or the order fulfillment server 152. The intermediary server 154 may be configured to transmit the order-specific information to the industrial control server 114. In some embodiments, the industrial control server 114 is configured to cause the robotic arm 104 to pick and place packages 12 in accordance with the order-specific information received from the intermediary server 154. The industrial control server 114 may be configured to receive order-specific information for a pending order and determine a corresponding pick site where the requested product is stored. For example, the industrial control server 114 may be configured to determine, based on the designated pick site information, which of the pick sites 106 positioned within the work cell 102 include a stack 10 of packages 12 that match the requested product.

In some embodiments, the industrial control server 114 is configured to cause the image capture system 108 to capture an image of the determined pick site 106. For example, in response to determining which pick site 106 within the work cell 102 include packages 12 corresponding to the requested product, the industrial control server 114 may be configured to cause an image capture device 110 positioned above that pick site 106 to capture an image thereof (e.g., the image 20 shown in FIG. 13). The industrial control server 114 may be configured to determine a package 12 in the stack 10 positioned at that pick site 106 to pick and the package position information thereof as described above with reference to FIGS. 14-16.

In some embodiments, the industrial control server 114 is configured to cause the container erector 138 to erect a container 30 in accordance with the received order-specific information. For example, the industrial control server 114 may be configured to transmit a request to the container erector 138 to cause the container erector 138 to erect a container 30 having dimensions defined by the container size information included in the order-specific information. In some instances, the container erector 138 may be configured to erect containers 30 of generally the same dimensions. In such instances, the industrial control server 114 may be configured to transmit the request to the container erector 138 to cause the container erector 138 to erect the container 30.

In some embodiments, the industrial control server 114 is configured to cause the indicia applicator 140 to generate and apply indicia to the erected container 30 in accordance with the received order-specific information. For example, the industrial control server 114 may be configured to cause the indicia applicator 140 to print on an adhesive label, indicia corresponding to the order-specific information and apply the adhesive label to the erected container 30. In some embodiments, the indicia includes shipping information such as, but not limited to, a customer name, shipping address, a unique order identifier (e.g., order number, barcode, QR code, or a combination thereof). For example, FIGS. 18A-18C illustrate an example of an erected container 30 being transported along the container conveyor 112 and having a label 34 applied thereto by the indicia applicator 140.

In some embodiments, the intermediary server 154 may be configured to, for each received order request, update a queue of pending orders including ranking the pending orders for processing based on the order-specific information. For example, the intermediary server 154 may be configured to receive order-specific information for a plurality of different order requests and generate and/or update a queue of pending order requests that includes a priority ranking of the order requests. Further to this example, in an instance where the intermediary server 154 receives a batch of ten order requests (e.g., orders 1-10) each having order-specific information, the intermediary server 154 may be configured to organize the order requests into a priority ranking (e.g., order 4 being higher priority than order 2 and so on). In this manner, the intermediary server 154 may be configured to cause the industrial control server 114 process order requests according to the determined priority ranking. For example, the intermediary server 154 may be configured to transmit to the industrial control server 114, the order-specific information of pending orders in the queue according to a priority ranking.

The intermediary server 154 may be configured to the warehouse management server 150 indications of changes in inventory level of packages 12 within the work cell 102 such that the warehouse management server 150 may maintain an accurate inventory level record. In some embodiments, the intermediary server 154 is configured to transmit an indication to the warehouse management server 154 that a selected package 12 has been prepared for shipping, after the robotic arm 104 has placed the selected package 12 in a container 30. For example, the intermediary server 154 may be configured to receive from the industrial control server 114 an indication that a package 12 corresponding to the order-specific information currently being processed has been placed in a container 30 for shipping. In response to receiving the indication from the industrial control server 114 that the package 12 has been prepared for shipping, the intermediary server 154 may be configured to transmit a corresponding indication to the warehouse management server 150. The warehouse management server 150 may be configured to, in response to receiving an indication from the intermediary server 154 that the package 12 has been prepared for shipping, update a stored inventory amount for the product associated with the package 12. The robotic pack station 100 of the present disclosure may be configured to automatically maintain an accurate record of inventory levels for a plurality of different products.

In some embodiments, the intermediary server 154 is configured to determine a work cell inventory amount of each specific product included in each stack 10 of packages 12 positioned within the work cell 102. For example, the intermediary server 154 may be configured to transmit a request to the industrial control server 114 to determine inventory levels for each stack 10 positioned at the pick sites 106 within the work cell 102. In some embodiments, in response to receiving the request to determine inventory amounts, the industrial control server 114 may be configured to cause the image capture system 108 to capture images of each pick site 106. The industrial control server 114 may be configured to determine an inventory amount of each stack 10 (e.g., a number of packages 12 included in the stack 10) based on the images. In some embodiments, the industrial control server 114 is configured to determine whether an inventory amount of each stack 10 is below a predetermined threshold based on the height of a stack 10. The image capture system 108 may be configured to capture an image of a stack 10 and transmit the image to the industrial control server 114. The industrial control server 114 may be configured to determine the highest point on that stack 10 relative to a ground surface based on the received image. For example, in response to receiving an image of the stack 10 shown in FIG. 13, the industrial control server 114 may be configured to determine that the highest point on the stack (e.g., a point on an uppermost package 12 of the stack 10, a point of a package 12 closest to the corresponding image capture device 110) is about 48 inches from the ground surface upon which the stack 10 rests. In some embodiments, if the determined height of the stack 10 is below a predetermined threshold, the industrial control server 114 may be configured to determine that the inventory amount of that stack is also below a predetermined threshold. For example, if the determined height of a stack 10 is less than or equal to about ten inches, the industrial control server 114 may be configured to determine that the inventory of that stack is low and requires replenishment.

The industrial control server 114 is configured to transmit an indication that the inventory amount for a packaged product 12 is below the predetermined threshold to the intermediary server 154. The intermediary server 154 may be configured to, in response to an inventory amount for a specific product being equal to or less than a predetermined threshold, transmit a request to the warehouse management server 150 for a predetermined restock amount of that specific product. For example, in an instance where the intermediary server 154 receives an indication that the inventory amount for a specific packaged product 12 is low (e.g., equal to or less than about eight), the intermediary server 154 may transmit a request to the warehouse management server 154 for a restock of that packaged product 12. In some embodiments, by transmitting a request for more inventory of a specific palletized packaged product 12 prior to the amount of the packaged product 12 available within a respective pick site 106 reaching zero, downtime from replenishment activities may be reduced. For example, the intermediary server 154 may be configured to transmit the request to retrieve the restock amount prior to the amount of that packaged product 12 within the pick site 106 reaching zero. The robotic pack station 100 of the present disclosure may be configured to automatically reduce downtime between restocks by automatically generating and transmitting requests for restock amounts prior to an amount of product within the work cell 102 reaching zero.

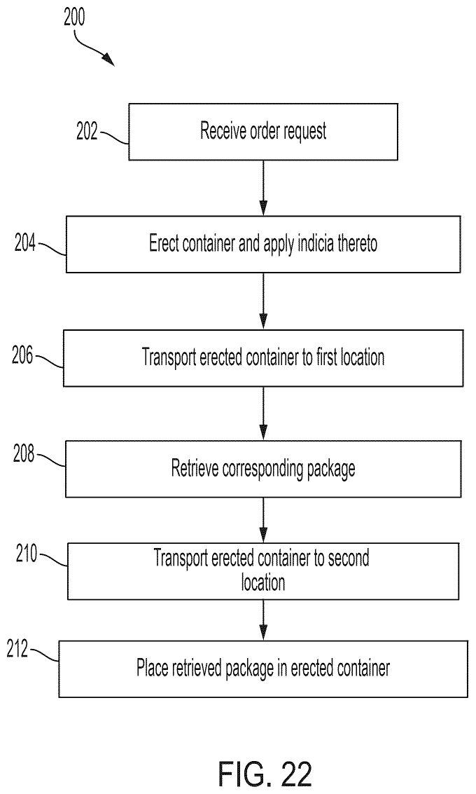

Referring to FIG. 22, there is shown a flowchart diagram illustrating a method, generally designated 200, of picking and packing a flexibly packaged product within a shipping container in accordance with an exemplary embodiment of the present disclosure. The method 200 may include the step 202 of receiving an order request for a packaged product. The step 202 may include at an industrial control server, receiving an order request for a packaged product, the order request including an indication of a requested product and customer specific information. For example, and as discussed above with reference to FIG. 21, the intermediary server 154 may transmit order-specific information corresponding to an order request to the industrial control server 114.

In some embodiments, the method 200 may include the step 204 of erecting a container and applying indicia thereto. The step 204 may include at a container erector in communication with the industrial control server, receiving a shipping container in a blank configuration and erecting the shipping container. For example, and as described above, the industrial control server 114 may be configured to cause the container erector 138 to erect a container 30 from a blank container stored therein in accordance with the received order-specific information. The step 204 may include at an indicia applicator, applying a label to the erected shipping container, the label including indicia corresponding to the customer specific information. For example, and as described above, the industrial control server 114 may be configured to cause the indicia applicator 140 to apply a label 34 to the erected container 30.

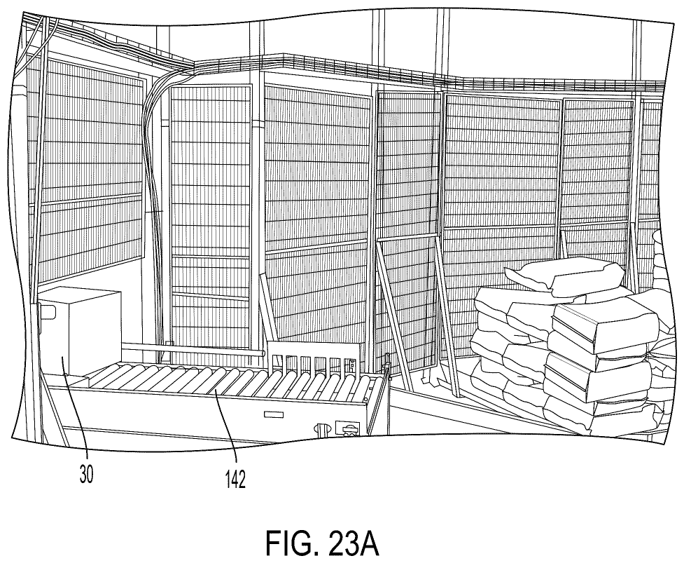

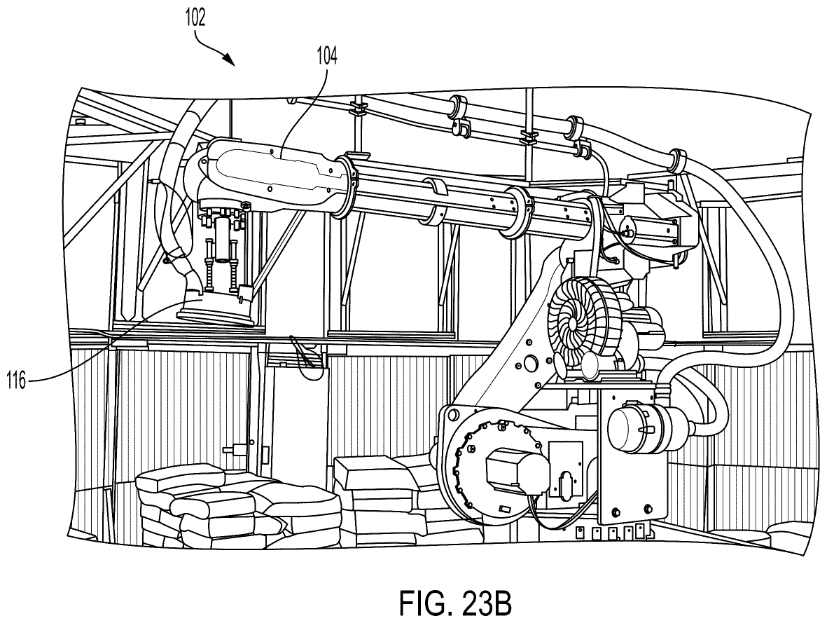

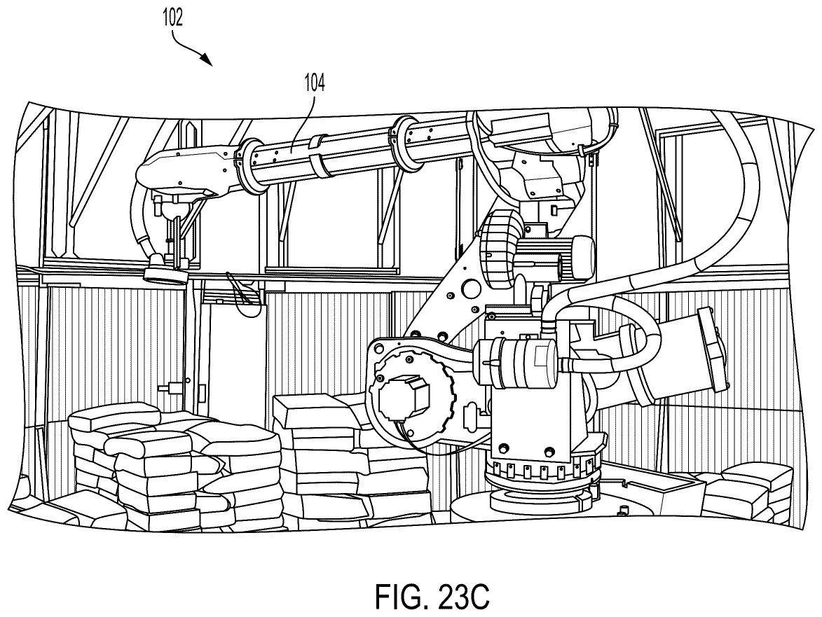

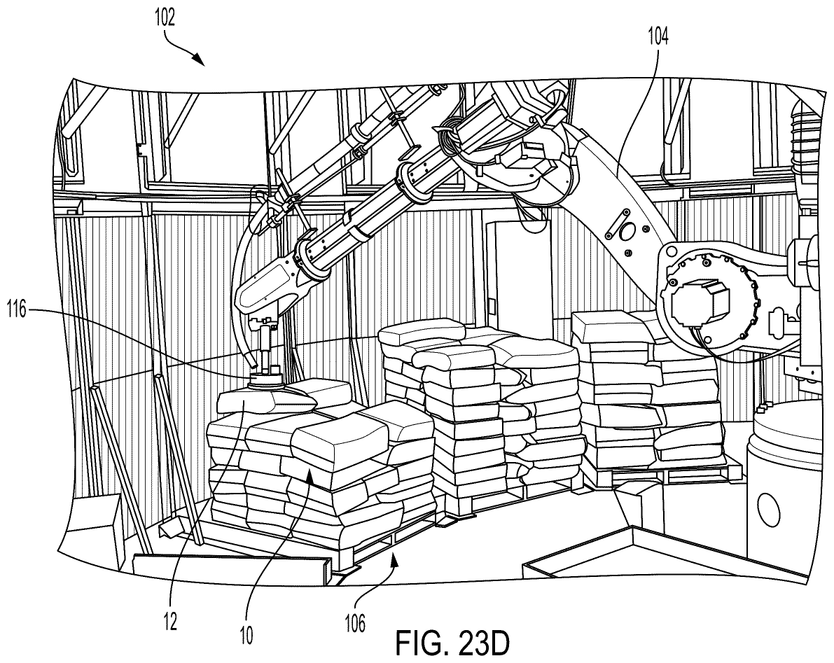

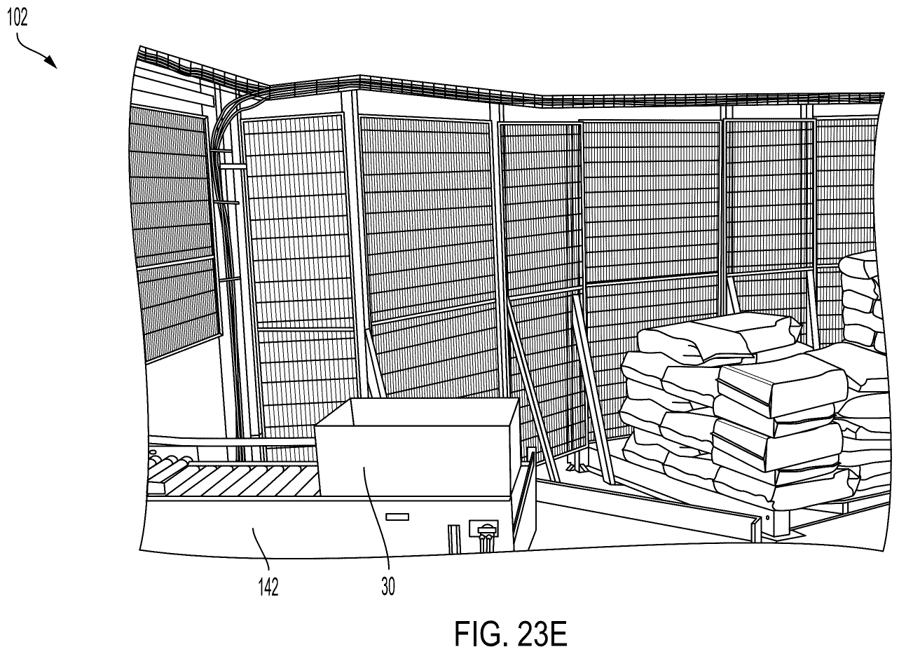

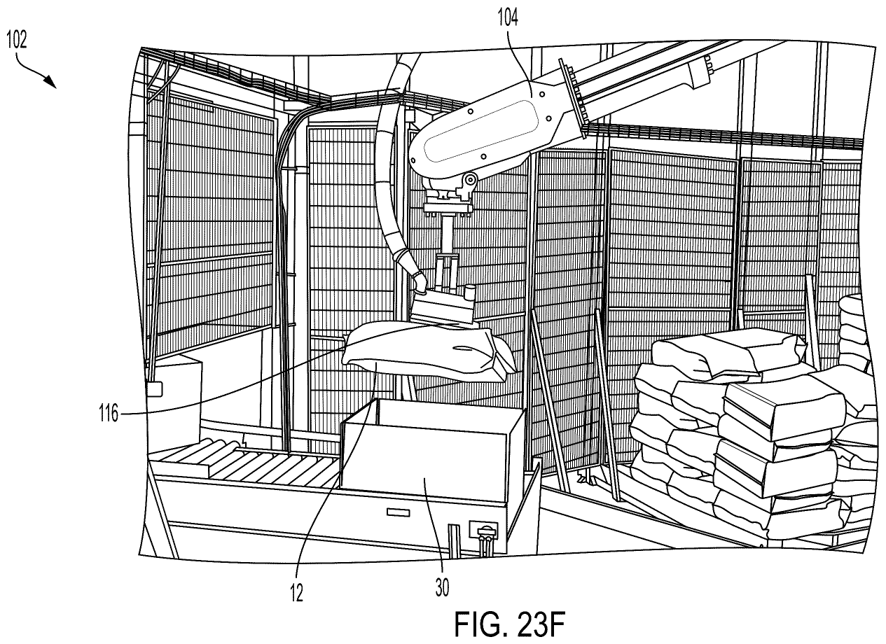

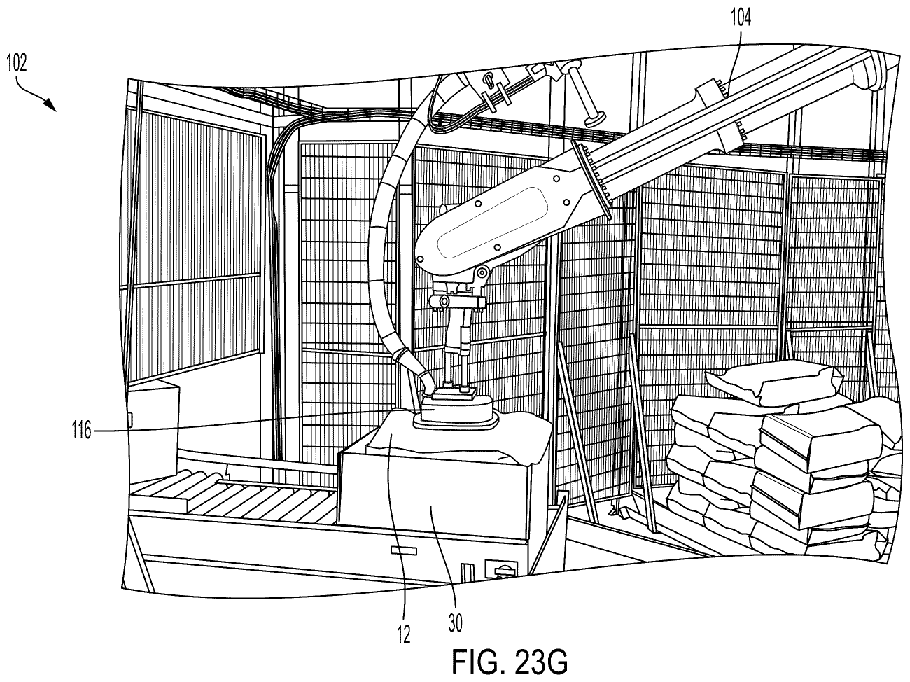

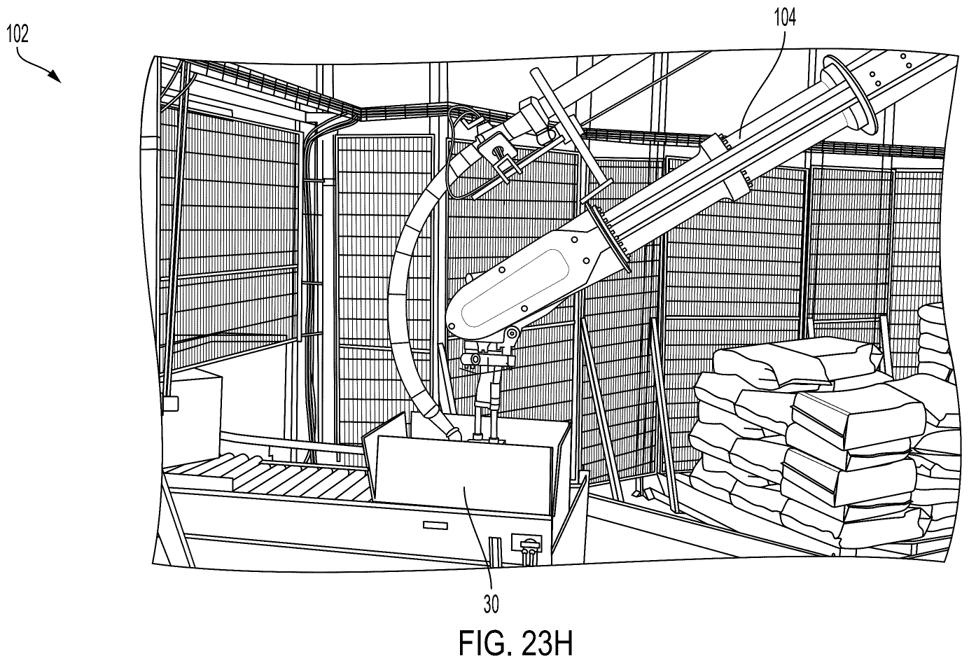

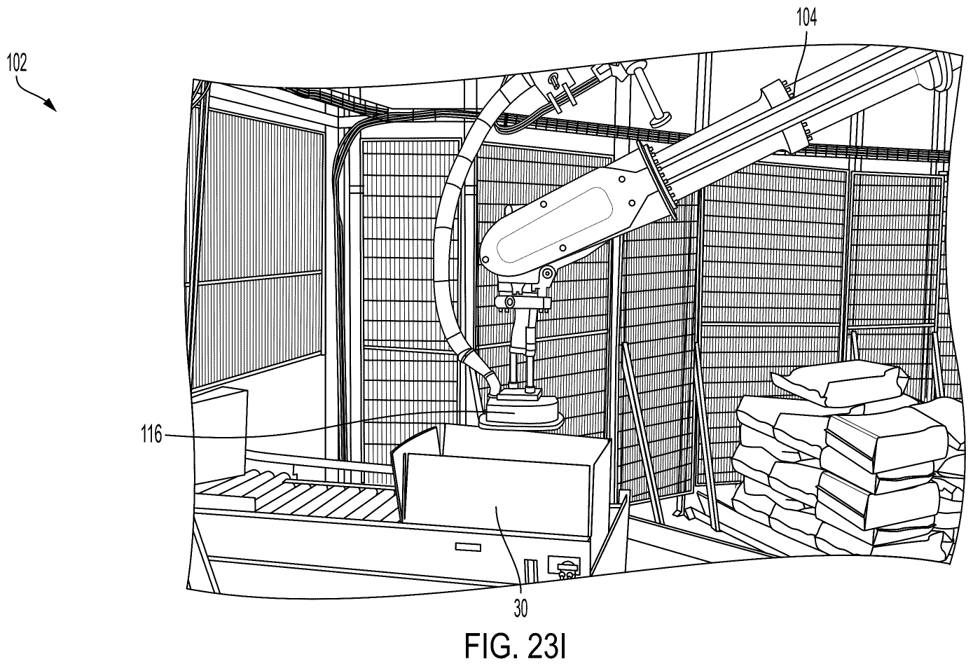

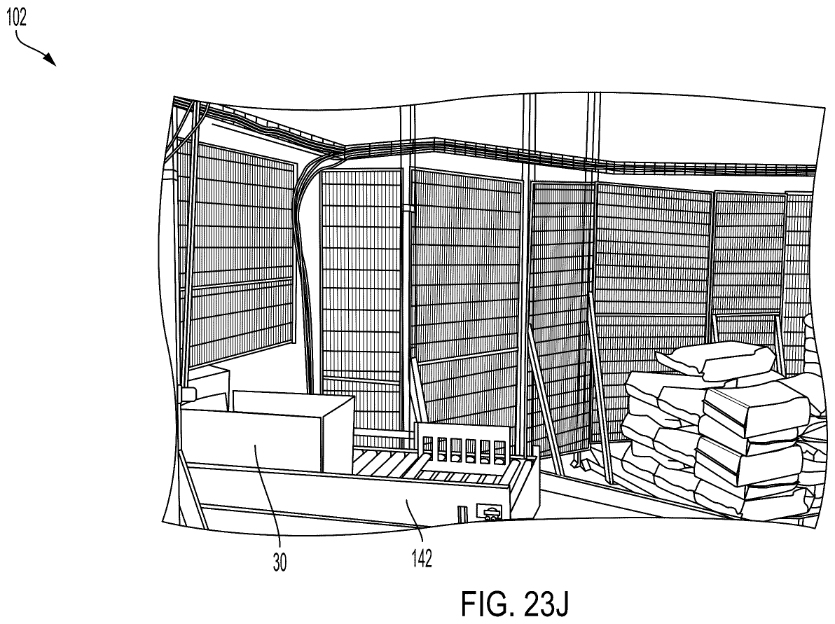

In some embodiments, the method 200 may include the step 206 of transporting the erected container to a first location. The step 206 may include at the industrial control server, causing a container conveyor to transport the erected shipping container with the label applied thereto to a first location. For example, the industrial control server 114 may be configured to cause the container conveyor 112 to transport the erected container 30 to a first location that is proximate the first container sensor 146, as shown in FIG. 19B. At the first location the container 30 may be at a position that is proximate the transfer table 142 while remaining on the container conveyor 112. For example, and as shown in FIG. 23A, the container 30 is located at the first location.

In some embodiments, the step 206 may include at a first case detection device coupled to the case conveyor proximate the first location, detecting the presence of the erected shipping container and transmitting a first signal to the industrial control server. For example, in FIG. 23A, the first container sensor 146 (shown in FIG. 19B) may detect the presence of the container 30 and transmit a first signal to the industrial control server 114.

The method 200 may include the step 208 of retrieving a corresponding package in accordance with the order request. The step 208 may include, at the industrial control server causing a robotic arm with an end effector coupled thereto and positioned within a work cell, to retrieve a specific package corresponding to the requested product, wherein the specific package is located at a specific pick site of a plurality of pick sites radially disposed about the robotic arm. As discussed above, the industrial control server 114 may be configured to cause the robotic arm 104 positioned within the work cell 102 to determine which pick site 106 contains a stack 10 of packages corresponding to the requested product. For example, and as shown in FIGS. 23B-23D, the industrial control server 114 may cause the robotic arm 104 to position the end effector 116 at a corresponding package 12 and retrieve the package 12.

The method 200 may include the step 210 of transporting the erected container to a second location to receive the retrieved package. In some embodiments, the step 210 includes causing the case conveyor to transport the erected shipping container to a transfer table positioned within the work cell. For example, the industrial control server 114 may be configured to cause the case conveyor 112 to move the container 30 onto the transfer table 144 as discussed above. In some embodiments, the step 210 includes at a second case detection device coupled to the transfer table and in communication with the industrial control server, detecting the presence of the erected shipping container at a first position on the transfer table, and transmitting a second signal to the industrial control server. In some embodiments, the step 210 further includes at the industrial control server, in response to receiving the second signal, causing a displacement device to displace the erected shipping container from the first position on the transfer table to a second position on the transfer table and retain the erected shipping container at the second position. For example, and as described above with reference to FIGS. 20A-20B, the industrial control server 114 may be configured to cause the displacement rake 144 to move the container 30 to a retained position on the transfer table 142 in response to the second container sensor 148 detecting the presence of the container 30. FIG. 23E, shows another example of a container 30 in the retained position on the transfer table 142.

The method 200 may include the step 212 of placing the retrieved package into the erected container. In some embodiments, the step 212 includes causing the robotic arm to place the retrieved specific package within the erected shipping container. For example, the industrial control server 114 may be configured to cause the robotic arm 104 to place the package 12 into the container 30, as described above and as illustrated in FIGS. 23F-23I. In some embodiments, the method 200 may include transporting the packed container out of the work cell. For example, as shown in FIG. 23J industrial control server 114 may be configured to cause the transfer table 114 to transport the container 30 having stored therein the package 12 out of the work cell 102.

In some embodiments, steps 208 and 210 are performed simultaneously. For example, the industrial control server 114 may be configured to cause the robotic arm 104 to retrieve a package 12 while simultaneously causing the container conveyor 112 and transfer table 142 to position the container 30 in the retained position. In this manner, the overall time to pick and pack a package 12 may be reduced as compared to performing one step prior to the other.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

1. A robotic pack station comprising:
a work cell including a robotic arm with an end effector coupled thereto and a plurality of pick sites radially disposed about the robotic arm, each pick site comprising packages arranged in a stack;
an image capture system configured to capture images of the pick sites;
a container conveyor coupled to the work cell and configured to move one or more containers into the work cell;
an industrial control server in communication with the robotic arm and with the image capture system, the industrial control server configured to control movement of the robotic arm and actuation of the end effector to transfer selected packages from one of the plurality of pick sites to one of the containers conveyed into the work cell, based on the images; and
an order fulfillment server system in communication with the industrial control server, the order fulfillment server configured to transmit instructions to the industrial control server to cause the robotic arm to retrieve one or more packages containing requested products for placement in the container,
wherein the order fulfillment server system comprises:
a database storing product-specific information therein;
a warehouse management server configured to receive one or more product requests and retrieve product-specific information corresponding the one or more product requests; and
an intermediary server, in communication with the warehouse management server and in communication with the industrial control server, the intermediary server configured to receive order-specific information for a plurality of pending orders from the warehouse management server and, for each received pending order, update a queue of pending orders including ranking the pending orders for processing based on the order-specific information,
wherein the intermediary server is further configured to transmit to the industrial control server, the order-specific information of pending orders in the queue according to a priority ranking.

2. The robotic pack station of claim 1, wherein each package comprises a flexible outer film surrounding bulk material that engages the flexible outer film to conform the package into a first shape in an unpicked configuration and into a second shape in a picked configuration, wherein the first shape is different from the second shape.

3. The robotic pack station of claim 1, wherein one or more of the packages has a package footprint in the stack defined by a length and width of the package that is greater than a container footprint of a corresponding container.

4. The robotic pack station of claim 1, wherein adjacent stacked packages at the pick site are arranged in an overlapping configuration.

5. The robotic pack station of claim 4, wherein the end effector comprises a suction based end effector.

6-7. (canceled)

8. The robotic pack station of claim 1, wherein the order-specific information for each of the plurality of orders including at least one of i) product identity information, ii) container size information, iii) order identifier information, iv) shipping information, v) order priority information, and vi) designated pick site information.

9. The robotic pack station of claim 8, wherein the industrial control server is configured to:
in response to receiving order-specific information for a pending order, determine a pick site corresponding to the order-specific information;
cause the image capture system to capture an image of the determined pick site;
determine, based on the image, package position information corresponding to a selected package at the determined pick site;
determine, based on the package position information, a pick point corresponding to a geometric center on the selected package; and
cause the robotic arm to pick the selected package at the pick point.

10. The robotic pack station of claim 9, wherein the determined package position information includes a determined package footprint defined by a long edge and short edge of the package, and
wherein the pick point is a center point of the package with respect to the long and short edges of the package.

11. The robotic pack station of claim 10, wherein the industrial control server is further configured to:
determine an orientation of the selected package within a 3-dimensional space based on the images and generate package orientation information;
cause the robotic arm to reorient the end effector from a first orientation to a second orientation such that the orientation of the end effector is generally the same as the orientation of the selected package and, while in the second orientation, activate the end effector such that the selected package is picked; and
control movement of the robotic arm such that the long and short edges of the selected package are aligned with a long edge and a short edge of the container conveyed into the work cell.

12. The robotic pack station of claim 9 further comprising:
a container erector coupled to the container conveyor and in communication with the industrial control server, the container erector configured to erect the container selected from a store of containers of different sizes, based on the received order-specific information;
an indicia applicator configured to generate and apply an indicia to the erected container, the indicia including a visual indication associated with the order identifier information included in the received order-specific information.

13. The robotic pack station of claim 12, wherein in response to receiving order specific information corresponding to the pending order information, the industrial control server is configured to:
cause the container erector to erect a container having dimensions defined by the container size information;
cause the indicia applicator to generate and apply indicia to the erected container, the indicia including the order identifier information associated with the order-specific information; and
cause the container conveyor to transport the erected container having the indicia into the work cell.

14. The robotic pack station of claim 13 further comprising:
a transfer table positioned within the work cell and coupled to the container conveyor; and
a first container sensor coupled to the container conveyor and positioned between the indicia applicator and transfer table, the first container sensor in communication with the industrial control server and configured to detect the position of the container,
wherein the industrial control server is configured to:
in response to receiving an indication from the first container sensor that the container is detected, cause the robotic arm to retrieve the selected package.

15. The robotic pack station of claim 14 further comprising:
a second container sensor coupled to the transfer table, the second container sensor in communication with the industrial control server and configured to detect a position of the container on the transfer table; and
a displacement rake in communication with the industrial control server and configured to, in response to receiving an indication from the second container sensor that the container is detected, position the container in a retained position,
wherein the container is a regular slotted container and in the retained position the container is erected with four extended flaps and wherein the industrial control server is configured to, cause the robotic arm to place the selected package into the container in the retained position without folding one or more of the flaps.

16. The robotic pack station of claim 15, wherein the industrial control server is configured to place the selected package in the container such that the pick point of the selected package is positioned directly above a center point of the container within a tolerance of at least 3/1000 of a inch.

17. The robotic pack station of claim 1, wherein the plurality of pick sites includes at least thirteen pick sites spaced circumferentially about the robotic arm.

18. The robotic pack station of claim 1, wherein the intermediary server is configured to transmit an indication to the warehouse management server that the selected package has been prepared for shipping, after the robotic arm has placed the selected package in the container, and
wherein the warehouse management server is configured to, in response to receiving an indication from the intermediary server that the package has been prepared for shipping, update a stored inventory amount for the product associated with the package.

19. The robotic pack station of claim 1, wherein the intermediary server is configured to determine a work cell inventory amount of each specific product included in each stack of packages positioned within the work cell, and, in response to an inventory amount for a specific product being equal to or less than a predetermined threshold, transmit a request to the warehouse management server for a predetermined restock amount of that specific product.

20. The robotic pack station of claim 1, wherein the image capture system includes a plurality of image capture devices, each image capture device of the plurality of image capture devices being positioned to capture images of one of the pick sites.

21. The robotic pack station of claim 1, wherein each package in the stack is positioned in an orientation that is different from an orientation of at least one adjacent package in the stack.

22. A method of picking and packing a flexibly packaged product within a shipping container, the method comprising:
at an industrial control server, receiving an order request for a packaged product, the order request including an indication of a requested product and customer specific information;
at a container erector in communication with the industrial control server, receiving a shipping container in a blank configuration and erecting the shipping container;
at an indicia applicator, applying a label to the erected shipping container, the label including indicia corresponding to the customer specific information;
at the industrial control server, causing a container conveyor to transport the erected shipping container with the label applied thereto to a first location;
at a first case detection device coupled to the container conveyor proximate the first location, detecting a presence of the erected shipping container and transmitting a first signal to the industrial control server;
at the industrial control server, in response to receiving the first signal:
causing a robotic arm with an end effector coupled thereto and positioned within a work cell, to retrieve a specific package corresponding to the requested product, wherein the specific package is located at a specific pick site of a plurality of pick sites radially disposed about the robotic arm; and
causing the container conveyor to transport the erected shipping container to a transfer table positioned within the work cell;
at a second case detection device coupled to the transfer table and in communication with the industrial control server, detecting the presence of the erected shipping container at a first position on the transfer table, and transmitting a second signal to the industrial control server; and
at the industrial control server, in response to receiving the second signal:
causing a displacement device to displace the erected shipping container from the first position on the transfer table to a second position on the transfer table and retain the erected shipping container at the second position; and
causing the robotic arm to place the retrieved specific package within the erected shipping container.

23. The method of claim 22, wherein each pick site includes a plurality of packages and the packages are arranged in a plurality of stacks, each stack comprising a plurality of packages containing a bulk quantity of a product, and wherein each stacked package is positioned in an orientation that is different from at least one adjacent stacked package.

24. The method of claim 23, wherein causing the robotic arm to retrieve a specific package corresponding to the requested product includes, at the industrial control server:
automatically determining which of the pick sites includes the requested product;
causing an image capture system in communication with the industrial control server to capture an image of the determined pick site;
determine, based on the image, package position information corresponding to the pick site;
determine, based on the package position information, a packaged product for retrieval;
determine an center point of the packaged product for retrieval based on the image; and
cause the robotic arm to position the end effector at the determined center point with a tolerance of about 3/1000 of an inch; and
activate the end effector to cause the packaged product to be retrieved by the robotic arm.

25. The method of claim 24, wherein causing the robotic arm to place the retrieved package in the erected shipping container includes, at the industrial control server:
determining a center point of the erected package at the second position on the transfer table; and
causing the robotic arm to place the retrieved packaged product in the erected shipping container such that the center point of the retrieved packaged product is directly above the center point of the erected shipping container.
